(19) United States
(12) Patent Application Publication
(10) Pub. No.: US 2017/0078653 A1
(43) Pub. Date: Mar. 16, 2017

(54) SYSTEMS AND METHODS FOR PRODUCING A SURROUND VIEW

(71) Applicant: QUALCOMM Incorporated, San Diego, CA (US)

(72) Inventors: Ning Bi, San Diego, CA (US); Phi Hung Nguyen, San Diego, CA (US)

(21) Appl. No.: 15/141,663

(22) Filed: Apr. 28, 2016

Related U.S. Application Data
(60) Provisional application No. 62/218,792, filed on Sep. 15, 2015.

(51) Int. Cl. H04N 13/04; B60R 1/00; H04N 5/225; H04N 5/232; G06T 19/00; H04N 13/02

(52) U.S. Cl. CPC H04N 13/0456; G06T 19/006; H04N 13/0292; H04N 5/2254; H04N 5/23238; B60R 1/00; H04N 2013/0088

(57) ABSTRACT

An apparatus is described. The apparatus includes an electronic device. The electronic device is configured to provide a surround view based on a combination of at least one stereoscopic view range and at least one monoscopic view range. A method is also described. The method includes obtaining a plurality of images from a respective plurality of lenses. The method also includes avoiding an obstructing lens based on rendering a stereoscopic surround view including a first rendering ellipsoid and a second rendering ellipsoid. Rendering the stereoscopic surround view includes natively mapping a first image of the plurality of images to a first range of the first rendering ellipsoid and natively mapping the first image to a second range of the second rendering ellipsoid.

### RELATED APPLICATION

This application is related to and claims priority to U.S. Provisional Patent Application Ser. No. 62/218,792, filed Sep. 15, 2015, for “SYSTEMS AND METHODS FOR PRODUCING A STEREOSCOPIC SURROUND VIEW FROM FISHEYE CAMERAS.”

### FIELD OF DISCLOSURE

The present disclosure relates generally to electronic devices. More specifically, the present disclosure relates to systems and methods for producing a surround view.

### BACKGROUND

Some electronic devices (e.g., cameras, video camcorders, digital cameras, cellular phones, smart phones, computers, televisions, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, drones, smart applications, healthcare equipment, set-top boxes, etc.) capture and/or utilize images. For example, a smartphone may capture and/or process still and/or video images. The images may be processed, displayed, stored and/or transmitted. The images may portray a scene including a landscape and/or objects, for example.

In some cases, it may be difficult to portray captured scene depth. For example, it may be difficult to portray scene depth over a wide viewing range. As can be observed from this discussion, systems and methods that improve wide-angle image utilization and/or processing may be beneficial.

### SUMMARY

An apparatus is described. The apparatus includes an electronic device configured to provide a surround view based on a combination of at least one stereoscopic view range and at least one monoscopic view range.

The apparatus may include a plurality of lenses coupled to the apparatus. The lenses may be configured to obtain a plurality of images for the at least one stereoscopic view range and the at least monoscopic view range. The electronic device may be configured to render the at least one monoscopic view range in the surround view without an obstructing lens that may be coupled to the apparatus.

The apparatus may be a vehicle. The vehicle may include a plurality of lenses coupled to the vehicle. The plurality of lenses may be configured to obtain the at least one stereoscopic view range used to form the surround view.

The apparatus may include a display coupled to the vehicle. The display may be configured to output the surround view.

The apparatus may be a mobile device. The mobile device may include a plurality of lenses coupled to the mobile device. At least two of the plurality of lenses may be configured to obtain the at least one stereoscopic view range used to form the surround view.

The apparatus may include a display configured to output the surround view in augmented reality. The apparatus may include a processor configured to perform at least one of a fade and a blend in an overlap between at least one of the at least one stereoscopic view range and at least one of the at least one monoscopic view range.

The electronic device may be configured to render the surround view. The surround view may include a first ellipsoid view and a second ellipsoid view. The apparatus may include a processor configured to avoid reverse stereoscopic parallax based on an interchange of images corresponding to different lens pairs between the first ellipsoid view and the second ellipsoid view.

The apparatus may include a processor configured to avoid a realignment of images based on a projection of a plurality of images obtained by a plurality of lenses coupled to the apparatus. The apparatus may be a vehicle used in an Advanced Driver Assistance System (ADAS).

An apparatus is also described. The apparatus includes means for providing a surround view based on a combination of at least one stereoscopic view range and at least one monoscopic view range.

A method is also described. The method includes obtaining a plurality of images from a respective plurality of lenses. The method also includes avoiding an obstructing lens based on rendering a stereoscopic surround view including a first rendering ellipsoid and a second rendering ellipsoid. Rendering the stereoscopic surround view may include natively mapping a first image of the plurality of images to a first range of the first rendering ellipsoid and natively mapping the first image to a second range of the second rendering ellipsoid.

Rendering the stereoscopic surround view may include avoiding reverse stereoscopic parallax, including natively mapping the plurality of images to the first rendering ellipsoid and natively mapping the plurality of images to the second rendering ellipsoid. The plurality of images may be natively mapped to different ranges of the first rendering ellipsoid and the second rendering ellipsoid.

The plurality of lenses may be mounted on a vehicle. The stereoscopic surround view may be utilized in an Advanced Driver Assistance System (ADAS).

The plurality of lenses may be mounted on one or more drones. At least one of the plurality of lenses may have a field of view greater than 180 degrees.

The plurality of images may include a first hemiellipsoid, a second hemiellipsoid, a third hemiellipsoid, and a fourth hemiellipsoid. The first rendering ellipsoid may be a left rendering ellipsoid and the second rendering ellipsoid may be a right rendering ellipsoid. The left rendering ellipsoid may include at least a portion of the first hemiellipsoid in the first range, at least a portion of the second hemiellipsoid in the second range, at least a portion of the fourth hemiellipsoid in a third range, and at least a portion of the third hemiellipsoid in a fourth range. The right rendering ellipsoid may include at least a portion of the third hemiellipsoid in the first range, at least a portion of the first hemiellipsoid in the second range, at least a portion of the second hemiellipsoid in the third range, and at least a portion of the fourth hemiellipsoid in the fourth range.

The method may include performing at least one of blending and fading between at least two of the plurality of images. The method may include projecting the plurality of images directly to the first rendering ellipsoid and the second rendering ellipsoid to avoid performing realignment.

A computer-program product is also described. The computer-program product includes a non-transitory tangible computer-readable medium with instructions. The instructions include code for causing an electronic device to obtain a plurality of images from a respective plurality of lenses. The instructions also include code for causing the electronic device to avoid an obstructing lens based on code for causing the electronic device to render a stereoscopic surround view including a first rendering ellipsoid and a second rendering ellipsoid. The code for causing the electronic device to render the stereoscopic surround view includes code for causing the electronic device to natively map a first image of the plurality of images to a first range of the first rendering ellipsoid and to natively map the first image to a second range of the second rendering ellipsoid.

### BRIEF DESCRIPTION OF THE DRAWINGS

FIG. 1 is a diagram illustrating an example of one configuration of an apparatus;

FIG. 2 is a block diagram illustrating one example of a configuration of an apparatus in accordance with the systems and methods disclosed herein;

FIG. 3 is a block diagram illustrating one example of an apparatus in which systems and methods for producing a surround view may be implemented;

FIG. 4 is a diagram illustrating view ranges based on an arrangement of lenses;

FIG. 5 is a diagram illustrating an example of interchanging hemiellipsoids;

FIG. 6 is a flow diagram illustrating one configuration of a method for interchanging hemiellipsoids;

FIG. 7 illustrates examples of hemiellipsoids;

FIG. 8 is a diagram illustrating additional detail regarding avoiding obstructing lenses in a surround view;

FIG. 9A is a diagram illustrating an example of an approach for removing obstructing lenses from hemiellipsoids;

FIG. 9B illustrates an example of the hemiellipsoids after replacing obstructed wedges with unobstructed wedges as described in connection with FIG. 9A;

FIG. 9C is a diagram illustrating an example of a surround view that includes at least one stereoscopic view range and at least one monoscopic view range;

FIG. 10 is a flow diagram illustrating an example of one configuration of a method for rendering a surround view with at least one stereoscopic view range and at least one monoscopic view range;

FIG. 11 is a flow diagram illustrating one configuration of a method for interchanging hemiellipsoids;

FIG. 12 is flow diagram illustrating one configuration of a method for obtaining hemiellipsoids;

FIG. 13 is a diagram illustrating a functional approach for surround view playback;

FIG. 14 is a diagram illustrating one example of surround view playback;

FIG. 15 is a diagram illustrating an example of a configuration of the systems and methods disclosed herein;

FIG. 16 is a diagram illustrating another example of a configuration of the systems and methods disclosed herein;

FIG. 17 is a flow diagram illustrating one configuration of a method for avoiding an obstruction in a stereoscopic surround view;

FIG. 18 is a diagram illustrating an example of rendering shapes that may be rendered to produce a stereoscopic surround view;

FIG. 19 is a diagram illustrating another example of a configuration of the systems and methods disclosed herein;

FIG. 20 is a diagram illustrating another example of a configuration of the systems and methods disclosed herein;

FIG. 21 is a diagram illustrating another example of a configuration of the systems and methods disclosed herein;

FIG. 22 is a diagram illustrating another example of a configuration of the systems and methods disclosed herein; and

FIG. 23 illustrates certain components that may be included within an apparatus configured to implement various configurations of the systems and methods disclosed herein.

### DETAILED DESCRIPTION

The systems and methods disclosed herein may relate to stereoscopic surround image (e.g., video) capture and/or playback. For example, the systems and methods disclosed herein may provide approaches for stereoscopic surround (e.g., 360 degree in both horizontal and vertical directions) image and/or video capturing.

Some approaches to wide angle image capture are described as follows. In one approach, a double-sided fisheye-lens camera may be used to capture 360 degree image and video in a monoscopic view (but not in a stereoscopic view). Monoscopic images may not offer a sense of depth. For example, they may not provide differing perspectives to provide depth information (e.g., they may not utilize a concept of left versus right or front versus back).

Some approaches for stereoscopic images may include placing fisheye lenses on cars (e.g., front left (FL) camera, front right (FR) camera, back left (BL) camera and back right (BR) camera). However, the separation (D) between the lenses/cameras may be far, on order of a couple of meters. Accordingly, some approaches may utilize devices with large form factors (that utilize and/or require a large distance between fisheye lenses, for example).

Some approaches may only produce either (a) monoscopic (no depth or like seeing with only one eye) 360 degree images, (b) a 360 degree stereoscopic view but only for an upper hemisphere (like seeing only half of the surroundings) or (c) a 360 degree view but at only one height (e.g., only with an elevation angle of 0).

In some image capture systems, camera lenses may be co-located in the same plane, where lenses are separated by a physical distance so that a stereoscopic ellipsoid (e.g., sphere) image may be formed by synthesizing the pixels captured by the individual camera lenses and adjusting for the physical distance that separates these camera lenses. Some configurations of the systems and methods disclosed may involve a native mapping of pixels to form stereoscopic ellipsoid images without the need to synthesize the ellipsoid images separately and account for the physical separate distance of the lenses. Some image systems do not use the native mapping, because some image capture systems do not create stereoscopic ellipsoid views from pixels directly. Instead, some image systems may create stereoscopic views by copying two captured images and synthesizing the captured images to form a stereoscopic ellipsoid view.

In native mapping, for example, the pixels from the lenses may already capture stereoscopic image information because the cameras may be positioned to approximately match human eye separation distance. Native mapping may enable just rendering the geometry to visualize in stereoscopic. In synthesis (e.g., synthesizing captured views), some kind of disparity (e.g., depth) map of the scene may be computed. The disparity (e.g., depth) map may be used to determine how the pixels are interpolated or shifted. The pixels may need to be synthesized to approximately match human eye disparity.

Some image capture systems (with two cameras in the same plane separated by a distance) synthesize the captured images by selectively choosing pixels. These systems do not have images where the first lens is captured in the view of the second lens, and where the first lens subsequently appears after the second image capture from the second lens. In other words, a stereoscopic ellipsoid view does not include an obstruction of “the other” lens that is in the field of view of the capturing lens because of selective synthesis of pixels. Without selective synthesis to compensate for the distance between the lenses, native mapping of the pixels may be performed. Some image capture systems fail to remove the obstruction(s) of the other lens or any other obstruction in the capturing lens field of view by native mapping.

As can be observed from the foregoing discussion, a variety of problems may arise when attempting to produce a surround view (e.g., a stereoscopic surround view). One problem that may arise is a mapping problem. For example, assume that a device (e.g., a smart phone) includes two front-back pairs of lenses. For instance, an electronic device may include a first pair of lenses (e.g., fisheye lenses) on the left that include one lens facing the front and the other lens facing the back of the device, and a second pair of lenses on the right that include one lens facing the front and the other lens facing the back of the device. Each of the lenses may provide approximately hemispherical image data. Accordingly, each pair of lenses may provide an approximately spherical image, where the perspectives of the spherical images are displaced from each other.

One approach to rendering a stereoscopic surround view maps the left spherical image to a user's left eye and maps the right spherical image to a user's right eye. Due to the displacement (e.g., parallax) between the spherical images, the user may perceive depth while viewing to the front. However, when viewing to the back (e.g., rotating the viewpoints 180° in each of the spherical images), the spherical images no longer correspond to the user's eye position. For example, the image data is reversed from the user's eye positions, causing left/right views to be reversed. Reverse stereoscopic parallax may mean reversing view perspectives in relation to eye perspectives. In reverse stereoscopic parallax, for instance, the left eye sees a right view perspective and the right eye sees a left view perspective. This problem may cause a user to feel dizzy when looking at the rendered surround view.

Some configurations of the systems and methods disclosed herein may ameliorate and/or solve the mapping problem. For example, hemiellipsoids (e.g., hemispherical images) may be interchanged between lens pairs. For instance, a left rendering shape (e.g., ellipsoid, sphere, etc.) corresponding to a user's left eye may be rendered with image data from a hemiellipsoid corresponding to the first front-back lens pair and image data from a hemiellipsoid corresponding to the second front-back lens pair. Accordingly, the viewpoints of the images may correspond to the user's eye positions when viewing towards the front and back. It should be noted that the prefix “hemi,” as used herein may or may not denote exactly half. For example, a hemiellipsoid may be less than a full ellipsoid and may or may not be exactly half of an ellipsoid. In some configurations, a hemiellipsoid may span more or less than half of an ellipsoid. For example, a hemiellipsoid may span 160 degrees, 180 degrees, 220 degrees, 240 degrees, etc.

A disparity problem may arise when attempting to produce a surround view. Some approaches may capture hemispherical images from different directions (e.g., opposite direction, a front direction and a back direction, etc.). A disparity (e.g., offset) may exist between the hemispherical images. For example, one lens may be tilted relative to the other and/or may not be exactly aligned relative to the other. This may cause a disparity (e.g., vertical disparity) between the hemispherical images. In order to produce a surround view, some approaches may attempt to align the images, reduce the disparity and/or stitch the images. For example, pixels may be moved (e.g., shifted) in one or both images in an attempt to make a combined image seamless. However, the invisible line(s) that the pixels are moved to may not be consistent between cameras. Unless the disparity is taken into account (via calibration, for example), the disparity (e.g., vertical disparity) may remain. The disparity and/or moving the pixels to align the images may cause a user to feel dizzy and/or ill.

In some configurations of the systems and methods disclosed herein, realignment (e.g., moving pixels, stitching, etc.) may be avoided. For example, some configurations of the systems and methods disclosed herein may avoid realignment (e.g. moving pixels and/or stitching) by projecting each lens image directly to a sphere. The images may then be blended (at image edges, for example).

Capturing obstructions may be another problem that may arise when attempting to produce a surround view. For example, a lens may provide an image that includes part of the device (e.g., device housing, another lens, etc.). This may obstruct the scene that is sought to be captured.

In some configurations of the systems and methods disclosed herein, obstructions may be avoided using one or more approaches. In some approaches, obstructed ranges from a lens (e.g., from one pair of fisheye lenses) may be replaced with unobstructed ranges from another lens (e.g., from another pair of fisheye lenses). In some approaches, obstructions may be avoided by rendering a monoscopic view range (corresponding to an obstructed range, for example) and a stereoscopic view range in a surround view. For example, a surround view may be rendered as a hybrid of one or more stereoscopic view ranges and one or more monoscopic view ranges in some approaches (which may avoid obstructions, for instance). One or more of these approaches may be used in some configurations where the lenses have an approximately 180° field of view and/or where two or more lenses are mounted approximately coplanar.

In some configurations of the systems and methods disclosed herein, obstructions may be avoided using overlapping fields of view. For example, assume two pairs of front-back fisheye lenses mounted on a device (e.g., smartphone). Each of the fisheye lenses may have a field of view that is greater than 180°. In one implementation, for example, each fisheye lens may have a 240-degree field of view. A 60-degree overlap may be achieved by mounting the fisheye lenses back-to-back. Since there may be some thickness, the cameras may exhibit a disparity, despite being mounted back-to-back. Regions of interest (e.g., overlapping regions) may be determined. For example, regions of interest may be known and/or determined based on setting up the cameras.

Pixels may be copied to appropriate left and right eye locations (e.g., rendering ellipsoids (e.g., spheres) based on the regions of interest. In some approaches, one or more transformations may be performed (in addition to copying, for example) to enhance and/or blend the images (e.g., colors). In some implementations, the image(s) may be obstructed. For example, different cameras (e.g., two cameras) may see each other. Pixels (e.g., image information at the extremities) may be utilized to replace the pixels where the obstructions (e.g., lenses, cameras, etc.) appear.

A wide-angle camera may include at least one wide-angle lens, a wide-FOV camera may include at least one wide-FOV lens, a fisheye camera may include at least one fisheye lens, a normal camera may include at least one normal lens and/or a long-focus camera may include at least one long-focus lens. Normal cameras and/or normal lenses may produce normal images, which do not appear distorted (or that have only negligible distortion). Wide-angle lenses and wide-FOV lenses (e.g., wide-angle cameras, wide-FOV cameras) may have shorter focal lengths than normal lenses and/or may produce images with an expanded field of view. Wide-angle lenses and wide-FOV lenses (e.g., wide-angle cameras, wide-FOV cameras) may produce images with perspective distortion, where the image appears curved (e.g., straight lines in a scene appear curved in an image captured with a wide-angle or wide-FOV lens). For example, wide-angle lenses and/or wide-FOV lenses may produce wide-angle images, wide-FOV images, curved images, spherical images, hemispherical images, hemiellipsoidal images, fisheye images, etc. Long-focus lenses and/or long-focus cameras may have longer focal lengths than normal lenses and/or may produce images with a contracted field of view and/or that appear magnified.

As used herein, a “fisheye lens” may an example of a wide-angle and/or wide field-of-view (FOV) lens. For example, a fisheye camera may produce images with an angle of view between approximately 100 and 240 degrees. For instance, many fisheye lenses may have a FOV larger than 100 degrees. Some fisheye lenses have an FOV of at least 140 degrees. For example, some fisheye lenses used in the advanced driver assistance system (ADAS) context may have (but are not limited to) FOVs of 140 degrees or greater. Fisheye lenses may produce images that are panoramic and/or approximately ellipsoidal (e.g., spherical, hemispherical, hemiellipsoidal, etc.) in appearance. Fisheye cameras may generate images with large distortions. For instance, some horizontal lines in a scene captured by a fisheye camera may appear to be curved rather than straight. Accordingly, fisheye lenses may exhibit distortion and/or large FOVs in comparison with other lenses (e.g., regular cameras).

It should be noted that several examples of the systems and methods disclosed herein may be described in terms of fisheye lenses, fisheye cameras and/or fisheye images. It should be noted that the systems and methods disclosed herein may be additionally or alternatively applied in conjunction with one or more normal lenses, wide-angle lenses, wide-FOV lenses, long-focus lenses, normal cameras, wide-angle cameras, wide-FOV cameras, long-focus cameras, normal images, wide-angle images, wide-FOV images and/or long-focus images, etc. Accordingly, examples that refer to one or more “fisheye cameras,” “fisheye lenses” and/or “fisheye images” may additionally or alternatively disclose other corresponding examples with normal lenses, wide-angle lenses, wide-FOV lenses, long-focus lenses, normal cameras, wide-angle cameras, wide-FOV cameras, long-focus cameras, normal images, wide-angle images, wide-FOV images and/or long-focus images, etc., instead of fisheye cameras, fisheye lenses and/or fisheye images. General references to one or more “cameras” may refer to any or all of normal cameras, wide-angle cameras, wide-FOV cameras, fisheye cameras and/or long-focus cameras, etc. General references to one or more “lenses” or “optical systems” may refer to any or all of normal lenses, wide-angle lenses, wide-FOV lenses, fisheye lenses and/or long-focus lenses, etc. General references to one or more “images” may refer to any or all of normal images, wide-angle images, wide-FOV images, fisheye images and/or long-focus images.

The systems and methods disclosed herein may be applied in many contexts, devices and/or systems. For example, the systems and methods disclosed herein may be implemented in electronic devices, vehicles, drones, cameras, computers, security systems, wearable devices (e.g., action cameras), airplanes, boats, recreational vehicles, virtual reality (VR) devices (e.g., VR headsets), augmented reality (AR) devices (e.g., AR headsets), etc.

Fisheye cameras may be installed in multiple positions. For example, four cameras may be positioned with two cameras in the front and two cameras in the back of an apparatus, electronic device, vehicle, drone, etc. Many other positions may be implemented in accordance with the systems and methods disclosed herein. Different fisheye cameras may have different tilt angles. The fisheye images from the fisheye cameras may have overlapping regions. In some configurations, more or fewer than four cameras may be installed and used for generation of a combined view (e.g., surround view) of 360 degrees or less than 360 degrees. A combined view may be a combination of images that provides a larger angle of view than each individual image alone. A surround view may be a combined view that partially or fully surrounds one or more objects (e.g., vehicle, drone, building, smartphone, etc.). In some configurations, the combined view (e.g., surround view) generated from the wide FOV cameras may be used to generate a stereoscopic three-dimensional (3D) combined view (e.g., surround view). How to connect the output images from multiple lenses to generate a combined view (e.g., a clear large FOV (such as 360 degree) surround view) presents a challenging problem.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

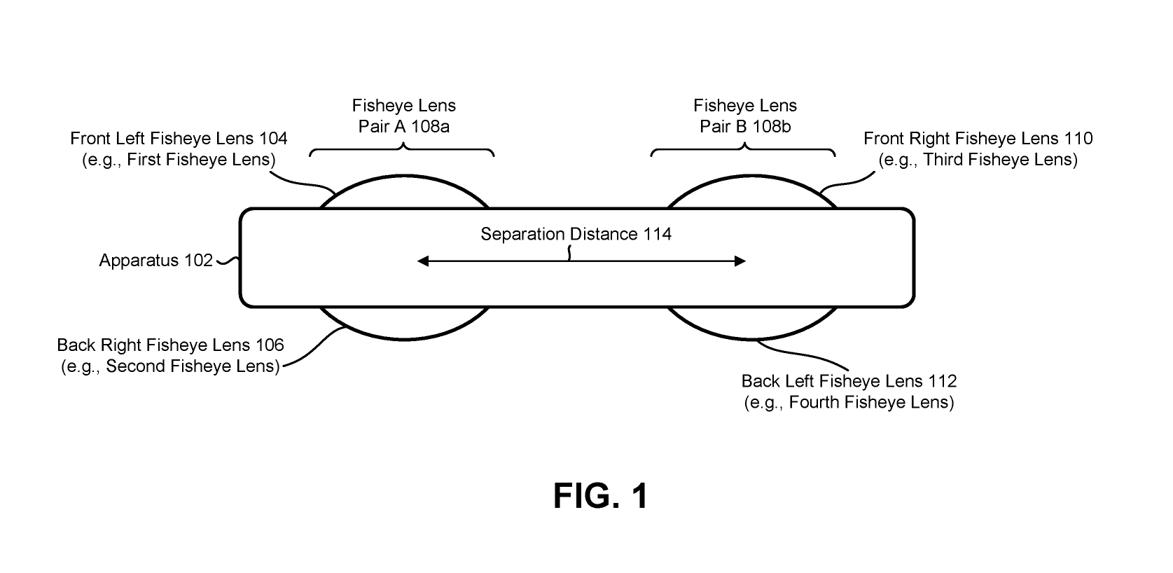

FIG. 1 is a diagram illustrating an example of one configuration of an apparatus 102. In some configurations of the systems and methods disclosed herein, two pairs 108a-b of fisheye lenses may be coupled to (e.g., included in) an apparatus 102. As used herein, the term “couple” may mean directly or indirectly connected. The term “couple” may be used in mechanical and/or electronic contexts. For instance, a front left fisheye lens 104 may be mechanically coupled to (e.g., attached to, mounted on, etc.) the apparatus 102, while an image sensor may be electronically coupled to a processor. A line and/or arrow between elements or components in the Figures may indicate a coupling.

A top-down view of an apparatus 102 is illustrated in FIG. 1. In this example, the apparatus 102 includes a front left fisheye lens 104, a back right fisheye lens 106, a front right fisheye lens 110 and a back left fisheye lens 112.

As illustrated in FIG. 1, the apparatus 102 may include fisheye lens pair A 108a and fisheye lens pair B 108b. Fisheye lens pair A 108a may be mounted at a separation distance 114 from fisheye lens pair B 108b. For example, the front left fisheye lens 104 and the back right fisheye lens 106 may form fisheye lens pair A 108a (e.g., a double fisheye lens). Additionally or alternatively, the front right fisheye lens 110 and the back left fisheye lens 112 may form fisheye lens pair B 108b (e.g., a double fisheye lens).

The fisheye lenses 104, 106, 110, 112 may be utilized to capture a stereoscopic surround image and/or stereoscopic surround video. For instance, two monoscopic 360 degree image and video capture double fisheye lenses may be mounted relatively closely together on one integrated device (e.g., camera, smartphone, mobile device, vehicle, drone, etc.) to capture a stereoscopic surround image.

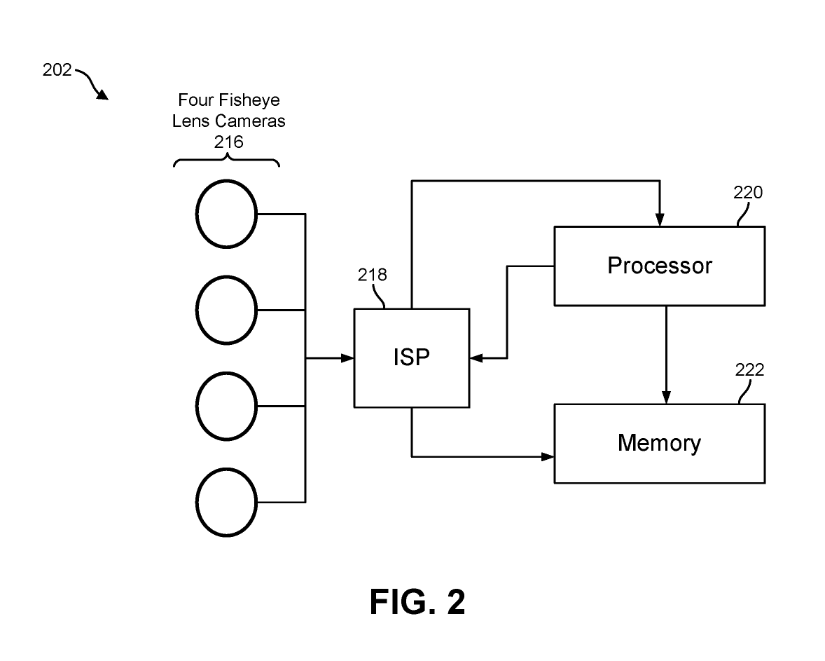

FIG. 2 is a block diagram illustrating one example of a configuration of an apparatus 202 in accordance with the systems and methods disclosed herein. In this example, the apparatus 202 may include four fisheye lens cameras 216, an image signal processor (ISP) 218, a processor 220 and a memory 222. The apparatus 202 may capture a stereoscopic surround image (and/or video) in accordance with the systems and methods disclosed herein.

Each of the fisheye lens cameras 216 may be wide-angle cameras. For example, each the fisheye lens cameras may capture approximately 180 degrees or more of a scene. Each of the fisheye lens cameras may include an image sensor and an optical system (e.g., lens or lenses) for capturing image information in some configurations. The fisheye lens cameras 216 may be coupled to an ISP 218.

For example, the apparatus 202 may include an image signal processor (ISP) 218 in some configurations. The image signal processor 218 may receive image data from the fisheye lens cameras 216 (e.g., raw sensor data and/or pre-processed sensor data). The image signal processor 218 may perform one or more operations on the image data. For example, the image signal processor 218 may perform decompanding, local tone mapping (LTM), filtering, scaling and/or cropping, etc. The image signal processor 218 may provide the resulting image data to the processor 220 and/or memory 222.

The memory 222 may store image data. For example, the memory 222 may store image data that has been processed by the ISP 218 and/or the processor 220. The ISP 218, the processor 220 and/or the memory 222 may be configured to perform one or more of the methods, steps, procedures and/or functions disclosed herein.

Some configurations of the systems and methods disclosed herein may provide surround view (e.g., stereoscopic surround view) generation from fisheye cameras. As used herein, a “fisheye camera” may be a wide-angle and/or wide field-of-view (FOV) camera. For example, a fisheye camera may produce images with an angle of view of approximately 180 degrees or more. This may produce images that are panoramic and/or hemiellipsoidal (e.g., hemispherical) in appearance.

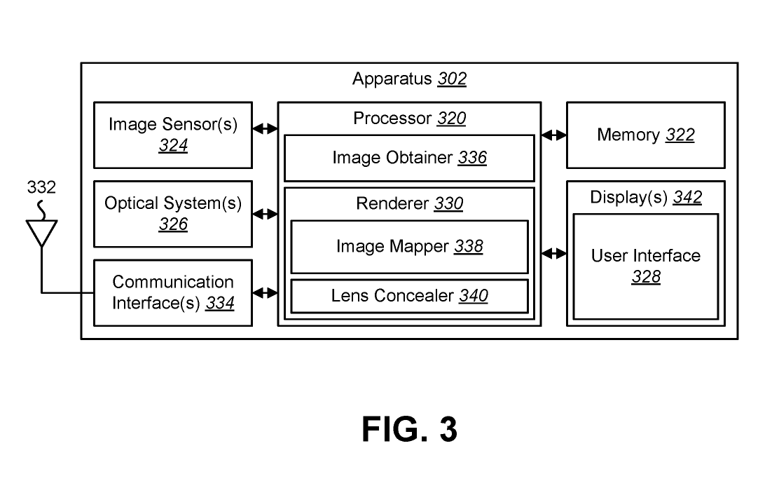

FIG. 3 is a block diagram illustrating one example of an apparatus 302 in which systems and methods for producing a surround view may be implemented. For instance, the apparatus 302 may be configured to generate a surround view (e.g., stereoscopic surround view) from fisheye cameras. Examples of the apparatus 302 include electronic devices, cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart applications, healthcare equipment, gaming consoles, personal digital assistants (PDAs), set-top boxes, appliances, etc. For instance, the apparatus 302 may be a vehicle used in an Advanced Driver Assistance System (ADAS). The apparatus 302 may include one or more components or elements. One or more of the components or elements may be implemented in hardware (e.g., circuitry) or a combination of hardware and software and/or firmware (e.g., a processor with instructions).

In some configurations, the apparatus 302 may include a processor 320, a memory 322, a display 342, one or more image sensors 324, one or more optical systems 326, and/or one or more communication interfaces 334. The processor 320 may be coupled to (e.g., in electronic communication with) the memory 322, display 342, image sensor(s) 324, optical system(s) 326, and/or communication interface(s) 334. The processor 320 may be a general-purpose single- or multi-chip microprocessor (e.g., an ARM), a special-purpose microprocessor (e.g., a digital signal processor (DSP)), a microcontroller, a programmable gate array, etc. The processor 320 may be referred to as a central processing unit (CPU). Although just a single processor 320 is shown in the apparatus 302, in an alternative configuration, a combination of processors (e.g., an ISP and an application processor, an ARM and a DSP, etc.) could be used. The processor 320 may be configured to implement one or more of the methods disclosed herein. For example, the processor 320 may be configured to produce the surround view from the fisheye images.

In some configurations, the apparatus 302 may perform one or more of the functions, procedures, methods, steps, etc., described in connection with one or more of FIGS. 1-23. Additionally or alternatively, the apparatus 302 may include one or more of the structures described in connection with one or more of FIGS. 1-23.

The communication interface(s) 334 may enable the apparatus 302 to communicate with one or more other apparatuses (e.g., electronic devices). For example, the communication interface(s) 334 may provide an interface for wired and/or wireless communications. In some configurations, the communication interface(s) 334 may be coupled to one or more antennas 332 for transmitting and/or receiving radio frequency (RF) signals. Additionally or alternatively, the communication interface(s) 334 may enable one or more kinds of wireline (e.g., Universal Serial Bus (USB), Ethernet, etc.) communication.

In some configurations, multiple communication interfaces 334 may be implemented and/or utilized. For example, one communication interface 334 may be a cellular (e.g., 3G, Long Term Evolution (LTE), CDMA, etc.) communication interface 334, another communication interface 334 may be an Ethernet interface, another communication interface 334 may be a universal serial bus (USB) interface, and yet another communication interface 334 may be a wireless local area network (WLAN) interface (e.g., Institute of Electrical and Electronics Engineers (IEEE) 802.11 interface). In some configurations, the communication interface 334 may send information (e.g., image information, surround view information, etc.) to and/or receive information from another apparatus or device (e.g., a vehicle, a smart phone, a camera, a display, a remote server, etc.).

The apparatus 302 may obtain one or more images (e.g., digital images, image frames, video, etc.). For example, the apparatus 302 may include the image sensor(s) 324 and the optical system(s) 326 (e.g., lenses) that focus images of scene(s) and/or object(s) that are located within the field of view of the optical system 326 onto the image sensor 324. A camera (e.g., a visual spectrum camera or otherwise) may include at least one image sensor and at least one optical system. Accordingly, the apparatus 302 may be one or more cameras and/or may include one or more cameras in some implementations. In some configurations, the image sensor(s) 324 may capture the one or more images. The optical system(s) 326 may be coupled to and/or controlled by the processor 320. Additionally or alternatively, the apparatus 302 may request and/or receive the one or more images from another apparatus or device (e.g., one or more external cameras coupled to the apparatus 302, a network server, traffic camera(s), drop camera(s), vehicle camera(s), web camera(s), etc.).

In some configurations, the apparatus 302 may request and/or receive the one or more images via the communication interface 334. For example, the apparatus 302 may or may not include camera(s) (e.g., image sensor(s) 324 and/or optical system(s) 326) and may receive images from one or more remote device(s). One or more of the images (e.g., image frames) may include one or more scene(s) and/or one or more object(s). In some examples, the image sensor(s) 324 and/or the optical system(s) 326 may be mechanically coupled to the apparatus 302 (e.g., may be attached to the body of a smartphone, to the hood of a car, etc.). The image sensor(s) 324 and/or optical system(s) 326 may be linked to the apparatus 302 via wired and/or wireless link. For example, the image sensor(s) 324 and/or optical system(s) 326 may be hardwired to a control mechanism (e.g., processor 320) in a vehicle or information captured by the image sensor(s) 324 and/or optical system(s) 326 may be wirelessly transmitted (e.g., streamed or otherwise wirelessly transported) to the control mechanism (e.g., processor 320).

In some configurations, the optical system(s) 326 may include one or more fisheye (e.g., wide-FOV) lenses. Accordingly, the optical system(s) 326 and image sensor(s) 324 may be components of one or more fisheye (e.g., wide-FOV) cameras that are coupled to (e.g., included in) the apparatus 302. Additionally or alternatively, the apparatus 302 may be coupled to and/or communicate with one or more external fisheye (e.g., wide FOV) cameras. In some implementations, two or more optical systems (e.g., lenses) may be situated approximately coplanar to each other. For example, two lenses may be situated (e.g., mounted) in a first plane and two other lenses may be situated in a second plane. Two or more planes may be approximately parallel to each other in some implementations.

In some configurations, the apparatus 302 may include an image data buffer (not shown). The image data buffer may buffer (e.g., store) image data from the image sensor(s) 324 and/or external camera(s). The buffered image data may be provided to the processor 320.

In some configurations, the apparatus 302 may include a camera software application and/or one or more displays 342. When the camera application is running, images of objects that are located within the field of view of the optical system(s) 326 may be captured by the image sensor(s) 324. The images that are being captured by the image sensor(s) 324 may be presented on the display 342. For example, the display(s) 342 may be configured to output a surround view. For instance, one or more surround view (e.g., stereoscopic surround view) images may be sent to the display(s) 342 for viewing by a user. In some configurations, these images may be played back from the memory 322, which may include image data of an earlier captured scene. The one or more images obtained by the apparatus 302 may be one or more video frames and/or one or more still images. In some implementations, the display(s) 342 may be augmented reality display(s) and/or virtual reality display(s) configured to output the surround view.

The processor 320 may include and/or implement an image obtainer 336. One or more of the image frames may be provided to the image obtainer 336. In some configurations, the image obtainer 336 may operate in accordance with one or more of the approaches, functions, procedures, steps and/or structures described in connection with one or more of FIGS. 1-23. The image obtainer 336 may obtain images (e.g., fisheye images, hemiellipsoids, hemispheres, etc.) from one or more cameras (e.g., normal cameras, wide-angle cameras, fisheye cameras, etc.). For example, the image obtainer 336 may receive image data from one or more image sensors 324 and/or from one or more external cameras. The images may be captured from multiple cameras (at different locations, for example). As described above, the image(s) may be captured from the image sensor(s) 324 (e.g., fisheye cameras) included in the apparatus 302 or may be captured from one or more remote camera(s) (e.g., remote fisheye cameras).

In some configurations, the image obtainer 336 may request and/or receive one or more images (e.g., fisheye images, hemiellipsoids, hemispheres, etc.). For example, the image obtainer 336 may request and/or receive one or more images from a remote device (e.g., external camera(s), remote server, remote electronic device, etc.) via the communication interface 334. The images obtained from the cameras may be processed by the processor 320 to produce a surround view (e.g., stereoscopic surround view).

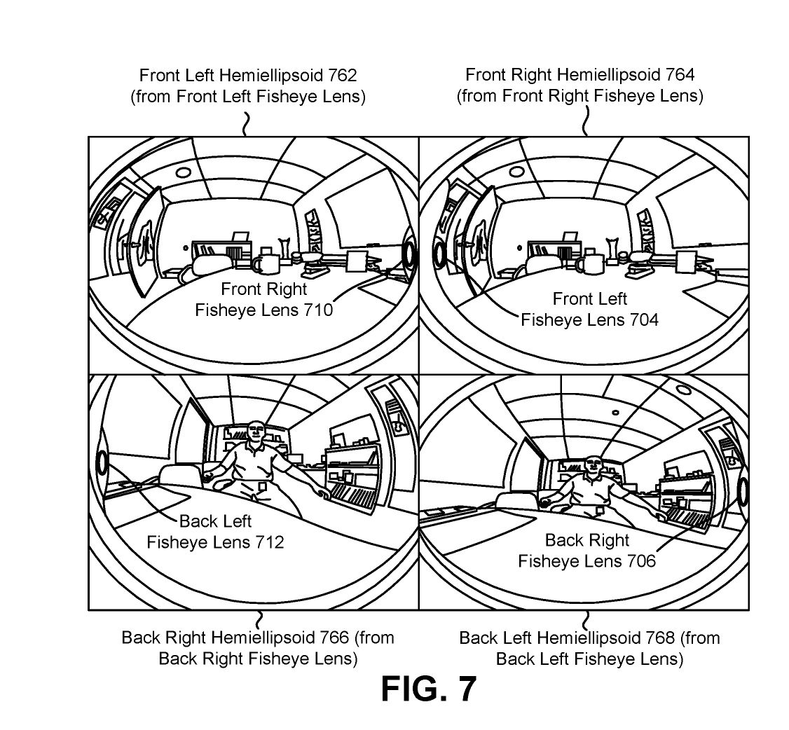

It should be noted that a “hemiellipsoid” may refer to the image data captured by a fisheye camera and/or to image data mapped to a curved surface. For example, a hemiellipsoid may include image data that appears curved and/or distorted in the shape of a hemiellipsoid (e.g., hemisphere). In some configurations, a hemiellipsoid may include two-dimensional (2D) image data. FIG. 7 includes examples of hemiellipsoids.

The processor 320 may include and/or implement a renderer 330. The renderer 330 may render a surround view (e.g., stereoscopic and/or monoscopic view) based on the image data (e.g., hemiellipsoids). For example, the renderer 330 may render a surround view that includes a first rendering shape (e.g., first ellipsoid, first ellipsoid view, first rendering sphere, left rendering shape, etc.) and a second rendering shape (e.g., second ellipsoid, second ellipsoid view, second rendering sphere, right rendering shape, etc.). The renderer 330 may include an image mapper 338 and/or a lens concealer 340.

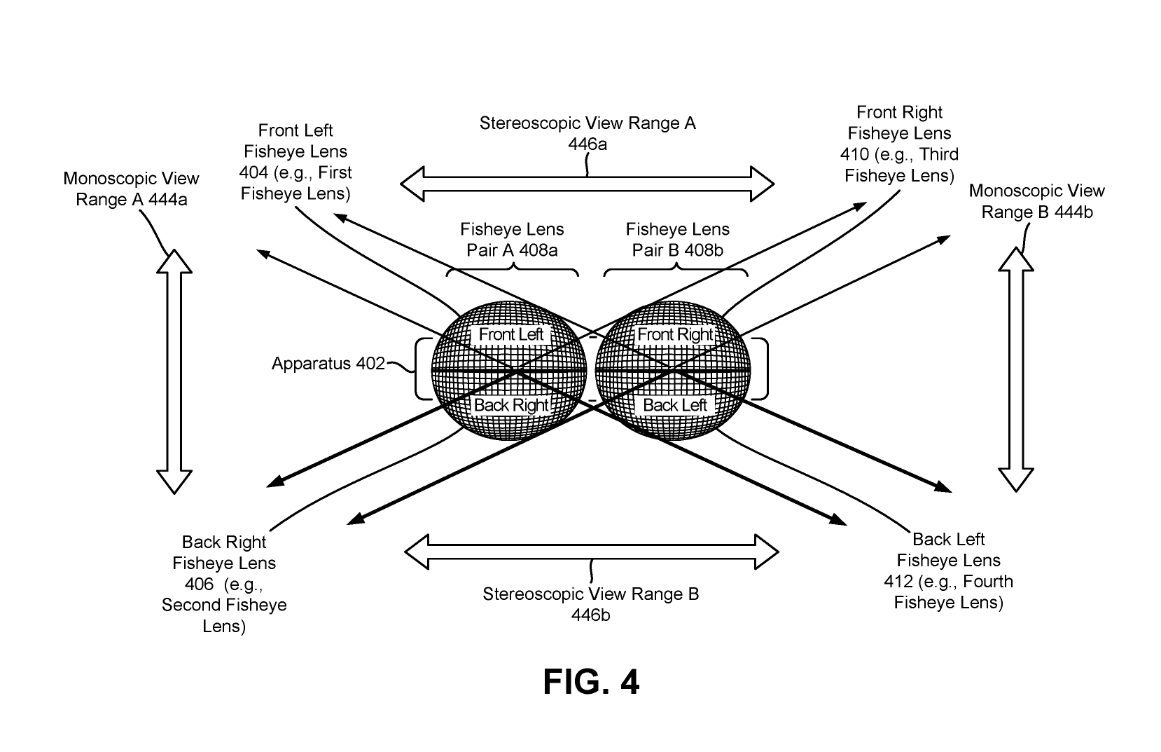

The processor 320 may include and/or implement an image mapper 338. The image mapper 338 may map images to rendering shapes. For example, the image mapper 338 may interchange images (e.g., image ranges, hemiellipsoids, etc.) between rendering shapes. This may be accomplished as described in connection with one or more of FIGS. 4-6, 14, 17-18. For example, the image mapper 338 may interchange images corresponding to different lens pairs between a first rendering shape (e.g., a first ellipsoid view) and a second rendering shape (e.g., a second ellipsoid view). Interchanging images corresponding to different lens pairs may avoid reverse stereoscopic parallax. Additionally or alternatively, the image mapper 338 may interchange two or more hemiellipsoids in order to help with a varying focal plane shift that occurs with different viewing angles.

The processor 320 may include and/or implement a lens concealer 340. The lens concealer 340 may conceal the appearance of fisheye lenses in a view. In some configurations, this may be accomplished as described in connection with one or more of FIGS. 7-10 and 15-22. In some approaches, the lens concealer may render a stereoscopic view (in all directions, for example) except for within ranges relative to an axis. For instance, assume that a front right fisheye lens is mounted next to a front left fisheye lens along an axis (e.g., in approximately the same plane). The front right fisheye lens may capture image data that shows the front left fisheye lens where the view is within a range around the axis to the left. Instead of rendering a stereoscopic view within that range, the lens concealer 340 may switch to a monoscopic view (from a single fisheye lens) within that range. Accordingly, a surround view may include at least one stereoscopic view range and at least one monoscopic view range in some approaches.

In some configurations, the renderer 330 (e.g., lens concealer 340) may perform a fade between the stereoscopic view and a monoscopic view and/or may blend the stereoscopic view and the monoscopic view. This may help to provide a more smooth transition between the stereoscopic view and the monoscopic view.

In some configurations, the renderer 330 may project images (e.g., hemiellipsoids) from a plurality of lenses to rendering shapes (e.g., ellipsoids, ellipsoid views, spheres, etc.). For example, the renderer 330 may natively map (e.g., directly project) images to the rendering shapes (instead of synthesizing views). In this way, the apparatus 302 may avoid realigning images in some approaches.

The processor 320 may provide the surround view (e.g., the stereoscopic view(s) and/or the monoscopic view(s). For example, the processor 320 may provide the view to the display(s) 342 for presentation. Additionally or alternatively, the processor 320 may send the view to another device (via the communication interface 334, for instance).

In some configurations, the surround view (e.g., stereoscopic surround view) may be utilized in an ADAS. For example, the surround view may be presented to a user in a vehicle in order to assist a driver in avoiding collisions. For instance, the surround view may be presented to a driver that is backing a vehicle, which may help the driver to avoid colliding the vehicle with another vehicle or pedestrian in a parking lot. Providing a stereoscopic view may assist the driver with depth perception.

The view may be rendered in a shape. For example, the view may be rendered as the interior of an ellipsoid (e.g., sphere).

The view may be presented from a viewpoint (e.g., perspective, camera angle, etc.). For example, a virtual reality headset may show a portion of the view from a particular perspective. The viewpoint may be located at the center of the rendered shape (e.g., ellipsoid, sphere, etc.)

In some configurations, the lens concealer 340 may avoid an obstructing lens in rendering a stereoscopic surround view. For example, the renderer 330 (e.g., lens concealer 340) may natively map images to rendering ellipsoids such that obstructions are avoided while providing a (partial or complete) stereoscopic surround view. In some approaches, the lens concealer 340 may natively map a first image to a range of a first rendering ellipsoid (e.g., sphere) and natively map the first image to a range of a second rendering ellipsoid. Each of the rendering ellipsoids may correspond to an eye of a user. More detail is provided in connection with one or more of FIGS. 4-22.

In some configurations, the renderer 330 (e.g., image mapper 338, lens concealer 340, etc.) may avoid reverse stereoscopic parallax. For example, the renderer 330 may natively map a plurality of images to a first rendering ellipsoid and may map the plurality of images to a second rendering ellipsoid, where the plurality of images are natively mapped to different ranges of the first rendering ellipsoid and the second rendering ellipsoid. More detail is provided in connection with one or more of FIGS. 4-22.

The memory 322 may store instructions and/or data. The processor 320 may access (e.g., read from and/or write to) the memory 322. Examples of instructions and/or data that may be stored by the memory 322 may include image data (e.g., hemiellipsoid data), rendering data (e.g., geometry data, geometry parameters, geometry viewpoint data, geometry shift data, geometry rotation data, etc.), range data (e.g., predetermined range(s) and/or range(s) in which obstructing lenses appear in the image data.), image obtainer 336 instructions, renderer 330 instructions, image mapper 338 instructions, and/or lens concealer 340 instructions, etc.

The memory 322 may store the images and instruction codes for performing operations by the processor 320. The memory 322 may be any electronic component capable of storing electronic information. The memory 322 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data and instructions may be stored in the memory 322. The instructions may be executable by the processor 320 to implement one or more of the methods described herein. Executing the instructions may involve the use of the data that is stored in the memory 322. When the processor 320 executes the instructions, various portions of the instructions may be loaded onto the processor 320, and various pieces of data may be loaded onto the processor 320.

In some configurations, the apparatus 302 may present a user interface 328 on the display 342. For example, the user interface 328 may enable a user to interact with the apparatus 302. In some configurations, the user interface 328 may enable a user to indicate preferences (e.g., view settings) and/or interact with the view. For example, the user interface 328 may receive one or more commands for changing the surround view (e.g., zooming in or out, rotating the surround view, shifting the surround view, changing surround view shape, changing the surround view viewpoint, etc.).

The display(s) 342 may be integrated into the apparatus 302 and/or may be coupled to the apparatus 302. For example, the apparatus 302 may be virtual reality headset with integrated displays. In another example, the apparatus 302 may be a computer that is coupled to a virtual reality headset with the displays 342. In yet another example, the apparatus 302 may be a vehicle. The vehicle may have a plurality of lenses configured to obtain images for producing the surround view. In some configurations, the vehicle may have one or more integrated displays 342 configured to output the surround view.

The apparatus 302 (e.g., processor 320) may optionally be coupled to, be part of (e.g., be integrated into), include and/or implement one or more kinds of devices. For example, the apparatus 302 may be implemented in a drone equipped with cameras. The apparatus 302 may provide a surround view of the scene captured by multiple fisheye cameras on the drone. In another example, the apparatus 302 (e.g., processor 320) may be implemented in an action camera (that includes multiple fisheye cameras).

It should be noted that one or more of the elements or components of the electronic device may be combined and/or divided. For example, the image obtainer 336, the renderer 330, the image mapper 338 and/or the lens concealer 340 may be combined. Additionally or alternatively, one or more of the image obtainer 336, the renderer 330, the image mapper 338 and/or the lens concealer 340 may be divided into elements or components that perform a subset of the operations thereof.

It should be noted that one or more of the elements or components described in connection with FIG. 3 may optional. For example, the apparatus 302 may not include and/or may not implement one or more of the image sensor(s) 324, the optical system(s) 326, the communication interface(s) 334, the antenna(s) 332, the processor 320, the memory 322 and/or the display(s) 342 in some configurations. Additionally or alternatively, the apparatus 302 may not implement the image mapper 338 or the lens concealer 340 in some configurations. In some implementations, the image mapper 338 and/or the lens concealer 340 may be implemented as independent circuitry (not as part of a processor, for example). In some configurations, a group of apparatuses (e.g., a drone swarm, group of vehicles, etc.) may coordinate to produce one or more surround views. For example, a set of apparatuses 302 may provide (e.g., send, transmit, etc.) image data to another apparatus 302 that may render one or more surround views based on the image data.

FIG. 4 is a diagram illustrating view ranges (e.g., fields of view) based on an arrangement of lenses (e.g., fisheye lenses). A top-down view of an apparatus 402 (e.g., fisheye lenses) is illustrated in FIG. 4. The apparatus 402 described in connection with FIG. 4 may be one example of one or more of the apparatuses 102, 202, 302 described herein. In this example, the apparatus 402 includes a front left fisheye lens 404, a back right fisheye lens 406, a front right fisheye lens 410 and a back left fisheye lens 412. As illustrated in FIG. 4, the apparatus 402 may include fisheye lens pair A 408a and fisheye lens pair B 408b. For example, the front left fisheye lens 404 and the back right fisheye lens 406 may form fisheye lens pair A 408a (e.g., a double fisheye lens). Additionally or alternatively, the front right fisheye lens 410 and the back left fisheye lens 412 may form fisheye lens pair B 408b (e.g., a double fisheye lens).

In accordance with the arrangement illustrated in FIG. 4, when a viewing direction is to the front, stereoscopic view range A 446a may be achieved because the positions of the two frontal lenses 404, 410 are laid out perpendicular to the viewing direction. In other words, the front field of stereoscopic view as shown in FIG. 4 may be achieved. Moreover, when a viewpoint direction is to the back, stereoscopic view range B 446b may be achieved because the positions of the two back lenses 406, 412 are laid out perpendicular to the viewing direction. In other words, the back field of stereoscopic view as shown in FIG. 4 may be achieved.

However, when the viewpoint direction is either to the left or to the right, monoscopic view range A 444a or monoscopic view range B 444b may be produced because the positions of the two lenses are laid out approximately in line with the viewing direction. In other words, the left field of mono view and the right field of mono view as shown in FIG. 4 may be produced. For example, a front part of monoscopic view range A 444a may be produced with an image from the front left fisheye lens 404 in order to avoid showing obstructing front left fisheye lens 404 from the perspective of the front right fisheye lens 410.

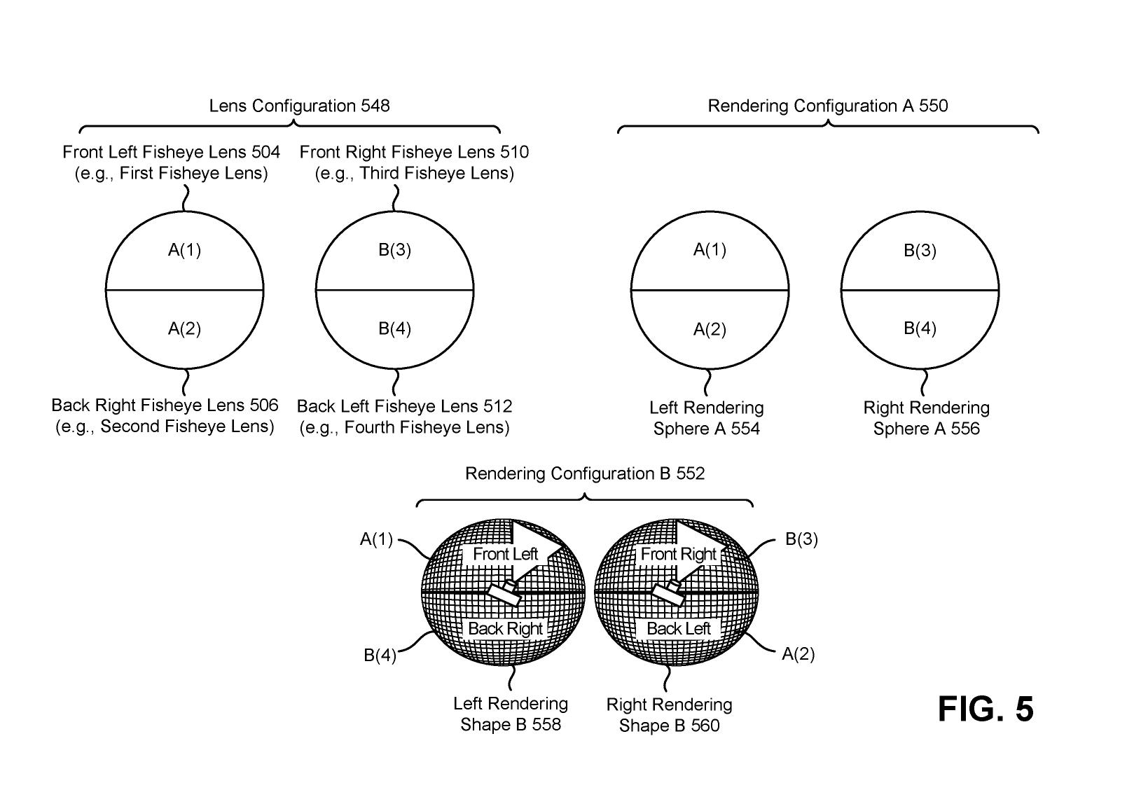

FIG. 5 is a diagram illustrating an example of interchanging hemiellipsoids. Specifically, FIG. 5 illustrates one example of a lens configuration 548. This is similar to the arrangement illustrated in FIG. 1. For example, an apparatus (e.g., 360 degree stereoscopic camera) may include four fisheye lenses 504, 506, 510, 512 as described in connection with FIG. 1 and/or as illustrated in the lens configuration in FIG. 5.

In particular, a front side of an apparatus may include a front left fisheye lens 504 and a front right fisheye lens 510. As illustrated, the front left fisheye lens 504 may be in a first fisheye lens pair, while the front right fisheye lens 510 may be in a second fisheye lens pair. Additionally, a back side of a device may include a back right fisheye lens 506 and a back left fisheye lens 512. The back right fisheye lens 506 may be in the first fisheye lens pair, while the back left fisheye lens 512 may be in the second fisheye lens pair. The labels A(1), A(2), B(1), and B(2) illustrate correspondences between the image capturing lens and the image rendering position in the rendering shapes.

The fisheye images (e.g., hemiellipsoids) may be mapped to and/or rendered on rendering shapes (e.g., ellipsoids, spheres, etc.). Each of the shapes may correspond to a side (e.g., left eye or right eye). For example, an apparatus (e.g., electronic device) may render a stereoscopic surround view (e.g., 360 degree stereoscopic view) in three dimensions (3D) with a head-mounted display (e.g., virtual reality headset, etc.) or other display (e.g., 3D TV, etc.). To view the images or videos captured by the camera, rendering shapes (e.g., virtual spheres) may be used to project the images or videos in a rendering process.

In FIG. 5, rendering configuration A 550 illustrates one example of a 3D rendering with a virtual sphere. The virtual sphere may be rendered with left rendering sphere A (e.g., left eye viewing sphere) and right rendering sphere A (e.g., right eye viewing sphere). If the first fisheye lens pair is mapped to a left rendering shape (e.g., virtual sphere for a left eye) and the second fisheye lens pair is mapped to a right rendering shape (e.g., virtual sphere for a right eye), the rendering shapes may correspond to incorrect sides when the viewpoint direction is to the back. For example, if a user views the rendered scene in a direction to the back, the back left fisheye lens 512 will provide the image for a user's right eye, while the back right fisheye lens 506 will provide the image for a user's left eye. This problem may be referred to as reverse stereoscopic parallax. For instance, if the hemiellipsoids are not interchanged, the right and left views are inverted when the viewpoint direction is to the back. Rendering configuration A 550 illustrates an example of this arrangement. Without interchanging hemiellipsoids, left rendering sphere A 554 would include image data from the back right fisheye lens 506 and right rendering sphere A 556 would include image data from the back left fisheye lens 512. In this case, a right-side view towards the back would be mapped to a user's left eye and a left-side view towards the back would be mapped to a user's right eye.

Rendering configuration B 552 illustrates interchanging hemiellipsoids. For example, the hemiellipsoids from the back right fisheye lens 506 and the back left fisheye lens 512 may be interchanged. For instance, when rendering left rendering shape B 558 (e.g., a left eye view), the hemiellipsoids (e.g., images or videos) captured by the front left fisheye lens 504 and the back left fisheye lens 512 may be mapped to left rendering shape B 558. For example, hemiellipsoids from the front left fisheye lens 504 and the back left fisheye lens 512 may be used as textures mapped on the left rendering shape B 558 (e.g., left view for the virtual sphere).

When rendering right rendering shape B 560 (e.g., a right eye view), the hemiellipsoids (e.g., images or videos) captured by the front right fisheye lens 510 and the back right fisheye lens 506 may be mapped to right rendering shape B 560. For example, hemiellipsoids from the front right fisheye lens 510 and the back right fisheye lens 506 may be used as textures mapped on the right rendering shape B 560 (e.g., right view for the virtual sphere). Interchanging the hemiellipsoids may ameliorate the reverse stereoscopic parallax problem. It should be noted that the cameras illustrated in left rendering shape B 558 and right rendering shape B 560 in FIG. 5 may illustrate an example of the viewing angle in left rendering shape B 558 and right rendering shape B 560.

It should be noted that the viewpoint location and/or direction (e.g., the virtual camera location and viewing direction) during rendering may be controlled by an input received from a user, either through manual input or automatic detection of user's position and orientation. The virtual camera location and viewing direction for both eyes may need to be in sync.

It should be noted that a zero-disparity plane in binocular vision can be modified by rotating the texture mapped to the rendering shapes (e.g., spheres) for the left eye and for the right eye differently. For example, left view (e.g., left eye view) may be rendered in a viewpoint direction alpha, while adding a relatively small angle to the alpha when rending the right view (e.g., right eye view). When the alpha is a positive value, this may be equivalent to moving the left eye viewport and right eye viewport closer to each other. This may result in moving the zero-disparity plane further away. When the alpha is negative, this may result in moving the zero-disparity plane closer.

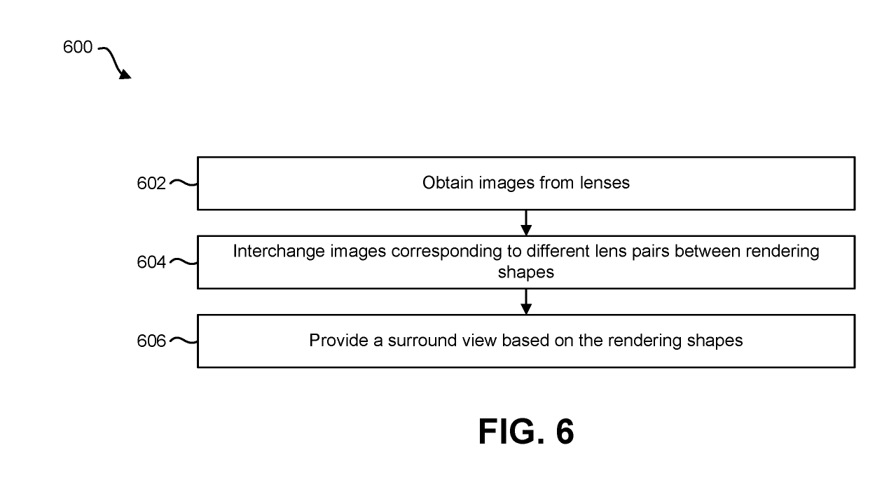

FIG. 6 is a flow diagram illustrating one configuration of a method 600 for interchanging hemiellipsoids. The method 600 may be performed by one or more of the apparatuses 102, 202, 302, 402 described in connection with one or more FIGS. 1-4. The apparatus 302 may obtain 602 images (e.g., hemiellipsoids) from lenses (e.g., fisheye lenses). This may be accomplished as described in connection with one or more of FIGS. 1-3 and 5. For example, the apparatus 302 may obtain 602 a plurality of images from a plurality of lenses.

The apparatus 302 may interchange 604 images (e.g., hemiellipsoids) corresponding to different lens pairs between rendering shapes (e.g., ellipsoids, ellipsoid views, etc.). This may be performed in order to avoid reverse stereoscopic parallax. For example, the apparatus 302 may interchange 604 the second hemiellipsoid with the fourth hemiellipsoid to render a surround view. This may be accomplished as described in connection with one or more of FIGS. 3 and 5.

The apparatus 302 may provide 606 a surround view based on the rendering shapes. This may be accomplished as described in connection with FIG. 3. For example, the apparatus 302 (e.g., processor 320) may provide the surround view to one or more displays on the apparatus and/or may send the surround view to another apparatus or device.

FIG. 7 illustrates examples of hemiellipsoids 762, 764, 766, 768. In particular, FIG. 7 illustrates a front left hemiellipsoid 762, a back right hemiellipsoid 766, a front right hemiellipsoid 764 and a back left hemiellipsoid 768. As can be observed in FIG. 7, a first fisheye lens pair (e.g., fisheye lens pair A 108a or a first double fisheye lens) that includes the front left fisheye lens 704 and the back right fisheye lens 706 may be captured in the front right hemiellipsoid 764 (from the front right fisheye lens 710) and the back left hemiellipsoid 768 (from the back left fisheye lens 712). Additionally, a second fisheye lens pair (e.g., fisheye lens pair B 108b or a second double fisheye lens) that includes the front right fisheye lens 710 and the back left fisheye lens 712 may be captured in the front left hemiellipsoid 762 (from the front left fisheye lens 704) and the back right hemiellipsoid 766 (from the back right fisheye lens 706). It should be noted that the back right hemiellipsoid 766 and the back left hemiellipsoid 768 may be swapped (e.g., interchanged) in accordance with the systems and methods disclosed herein.

If these hemiellipsoids were used to generate a stereoscopic image, the fisheye lens from the adjacent camera pair would obstruct the resulting captured stereoscopic image. For example, a rendered 360 degree composite image combines all four captured images. When a viewpoint direction is straight ahead (on-axis) in the rendered 360 degree composite image, the other fisheye lenses may not be visible. However, when the view direction is at an oblique angle, the other double fisheye lens may obstruct the view.

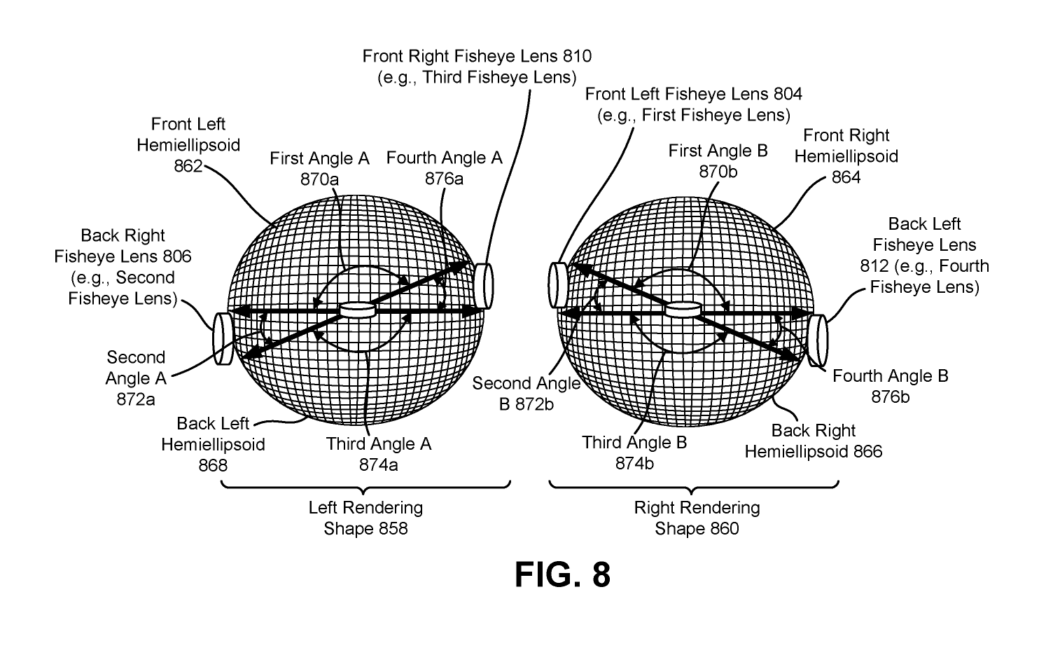

FIG. 8 is a diagram illustrating additional detail regarding avoiding obstructing lenses in a surround view. Specifically, FIG. 8 illustrates a left rendering shape 858 (e.g., ellipsoid) and a right rendering shape 860 (e.g., ellipsoid). The left rendering shape 858 may correspond to the left eye of a user and the right rendering shape 860 may correspond to the right eye of a user. This example may utilize a lens configuration similar to the lens configuration 548 described in connection with FIG. 5. For instance, a front left hemiellipsoid 862 may be obtained by a front left lens, a front right hemiellipsoid 864 may be obtained by a front right lens, a back left hemiellipsoid 868 may be obtained by a back left lens and a back right hemiellipsoid 866 may be obtained by a back right lens. The front left hemiellipsoid 862 and the back left hemiellipsoid 868 may be mapped (e.g., natively mapped) to the left rendering shape 858. The front right hemiellipsoid 864 and the back right hemiellipsoid 866 may be mapped (e.g., natively mapped) to the right rendering shape 860. It should be noted that the lenses illustrated in the center of the left rendering shape 858 and the right rendering shape 860 in FIG. 8 may illustrate an example of viewing origins in the left rendering shape 858 and the right rendering shape 860.

In this example, the rendering shapes 858, 860 may provide a stereoscopic view in the overlapping range of first angle A 870a and first angle B 870b (e.g., most of the front of a scene), and in the overlapping range of third angle A 874a and third angle B 874b (e.g., most of the back of a scene). FIG. 8 illustrates an approach to avoid showing other obstructing lenses during stereoscopic surround view (e.g., 360 degree stereoscopic view) rendering. For example, this approach may avoid showing and/or rendering one or more obstructing lenses during 3D rendering with a rendering shape (e.g., virtual sphere, virtual ellipsoid, etc.).

One example of an arrangement of a 360 degree stereoscopic camera with 4 fisheye lenses is given in connection with FIG. 1. To avoid displaying another lens (e.g., camera) as described in connection with FIG. 7, four segments may be treated specially during 3D-view rendering with a rendering shape (e.g., virtual ellipsoid, sphere, etc.). As illustrated in FIG. 8, the front left fisheye lens 804 may appear in second angle B 872b, the front right fisheye lens 810 may appear in fourth angle A 876a, the back right fisheye lens 806 may appear in second angle A 872a and the back left fisheye lens 812 may appear in fourth angle B 876b.

Second angle A 872a in the left rendering shape 858 may be an angular range starting at approximately 180 degrees to an ending angle (or a corresponding negative angular range) where the back right fisheye lens 806 is visible. For the left rendering shape 858, if the viewpoint direction turns towards the left past 180 degrees, the back right fisheye lens 806 appears in the second angle A 872a of the left rendering shape 858. However, the back right hemiellipsoid 866 is unobstructed in that range.

Second angle B 872b in the right rendering shape 860 is an oblique angle starting where the front left fisheye lens is visible to approximately 180 degrees. For the right rendering shape 860, if the viewpoint direction turns towards the left, the front left fisheye lens appears in second angle B 872b of the right rendering shape 860. However, the front left hemiellipsoid 862 is unobstructed in that range.

Fourth angle B 876b in the right rendering shape 860 may be an angular range starting at greater than 180 degrees to approximately 360 (or 0) degrees (or a corresponding negative angular range) where the back left fisheye lens 812 is visible. For the right rendering shape 860, if the viewpoint direction turns towards the right past 0 degrees, the back left fisheye lens 812 appears in the fourth angle B 876b of the right rendering shape 860. However, the back left hemiellipsoid is unobstructed in that range.

Fourth angle A 876a in the left rendering shape 858 may be an angular range starting at approximately 0 degrees to an ending angle (or a corresponding negative angular range) where the front right fisheye lens 810 is visible. For the left rendering shape 858, if the viewpoint direction turns towards the right, the front right fisheye lens 810 appears in fourth angle A 876a of the left rendering shape 858. However, the front right hemiellipsoid is unobstructed in that range.

For the left rendering shape 858 (e.g., left eye viewing sphere), one segment in the back left hemiellipsoid 868 may be replaced by the corresponding segment from the back right hemiellipsoid 866. Additionally or alternatively, a segment in the front left hemiellipsoid 862 may be replaced by the corresponding segment from the front right hemiellipsoid 864.

For the right rendering shape 860 (e.g., right eye viewing sphere), one segment in the back right hemiellipsoid 866 may be replaced by the corresponding segment from the back left hemiellipsoid 868. Additionally or alternatively, a segment in the front right hemiellipsoid 864 may be replaced by the corresponding segment from the front left hemiellipsoid 862.

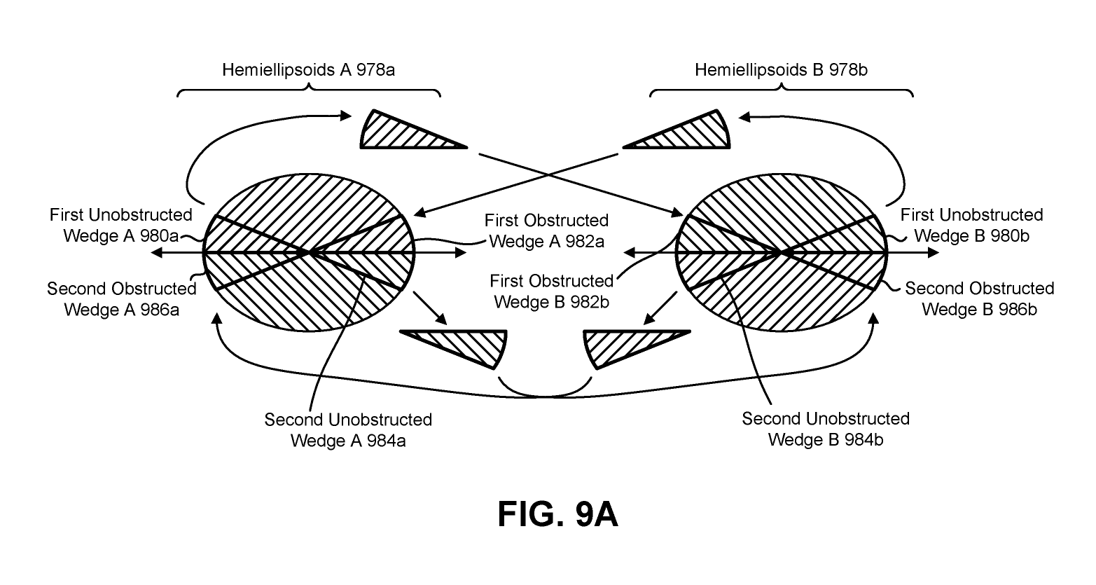

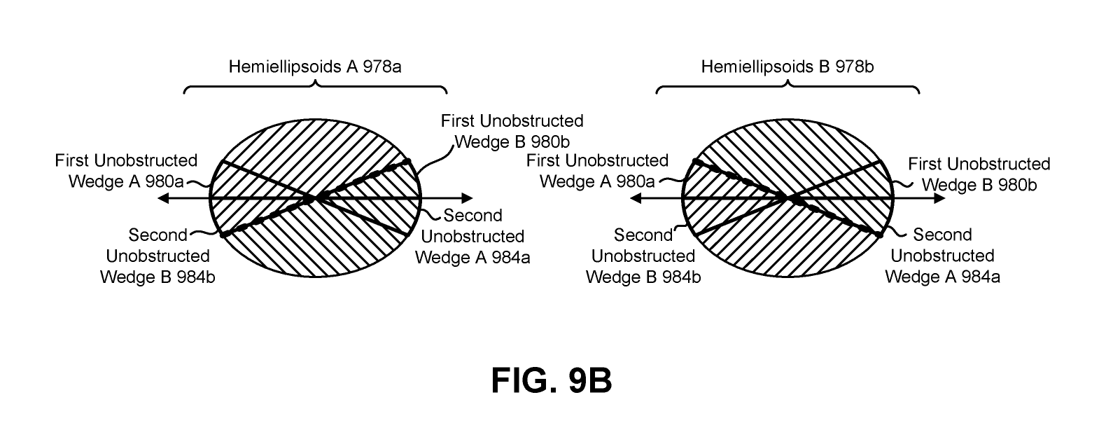

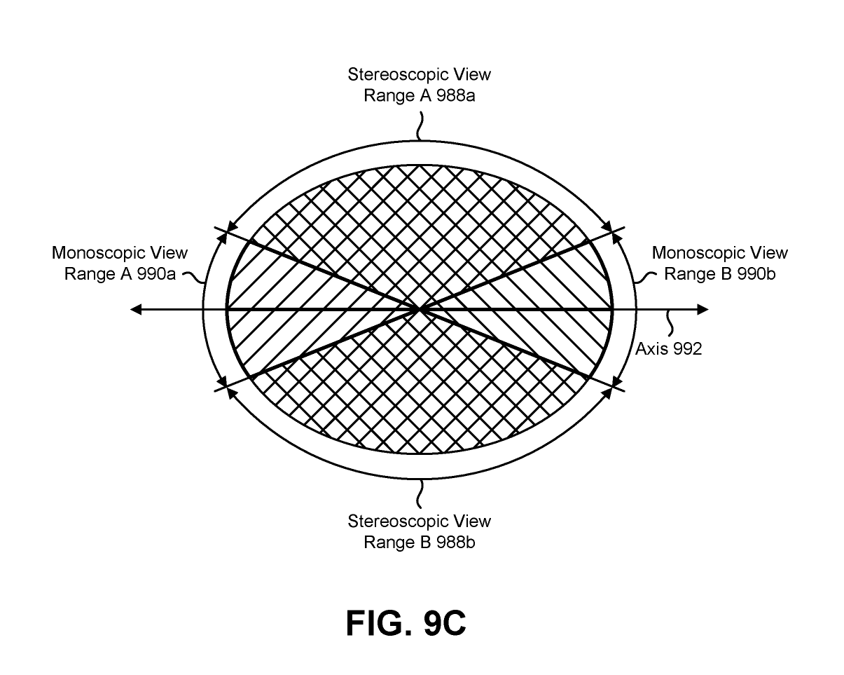

The replacement procedure may avoid showing and/or rendering one or more obstructing lenses (e.g., camera lenses). The replacement procedure may not affect viewing quality, since the left and the right view fields may be monoscopic views as described above in connection with FIG. 4. More detail is given in FIGS. 9A-C.

FIG. 9A is a diagram illustrating an example of an approach for removing obstructing lenses from hemiellipsoids. For example, the apparatus 302 may replace obstructed image ranges (where an obstructing lens appears) with unobstructed image ranges during rendering.

Hemiellipsoids A 978a (e.g., a front left hemiellipsoid and a back left hemiellipsoid) and hemiellipsoids B 978b (e.g., a front right hemiellipsoid and a back right hemiellipsoid) are illustrated in FIG. 9A. Hemiellipsoids A 978a may be mapped to a first rendering shape (e.g., ellipsoid, sphere, etc.) and hemiellipsoids B 978b may be mapped to a second rendering shape. As illustrated in FIG. 9A, each of hemiellipsoids A 978a and hemiellipsoids B 978b may include ranges (e.g., angular ranges) in which an obstruction (e.g., obstructing lens) is captured. These ranges may be referred to as obstructed wedges. For example, the obstruction(s) may be fisheye lenses as described in connection with FIGS. 7-8. It should be noted that the approaches described herein may be applied for other kinds of obstructions (e.g., part of the electronic device, part of a device housing, drone propeller, wall, etc.). For example, hemiellipsoids A 978a may include first obstructed wedge A 982a and second obstructed wedge A 986a. Additionally, hemiellipsoids B 978b may include first obstructed wedge B 982b and second obstructed wedge B 986b.

Moreover, each of hemiellipsoids A 978a and hemiellipsoids B 978b may include ranges (e.g., angular ranges) that are unobstructed (as described in connection with FIG. 8, for example). These ranges may be referred to as unobstructed wedges. For example, hemiellipsoids A 978a may include first unobstructed wedge A 980a and second unobstructed wedge A 984a. Additionally, hemiellipsoids B 978b may include first unobstructed wedge B 980b and second unobstructed wedge B 984b.

The apparatus 302 may replace obstructed wedges with unobstructed wedges during rendering to get rid of obstructing fisheye lenses in the image data. For example, the apparatus 302 may replace first obstructed wedge A 982a with first unobstructed wedge B 980b, may replace second obstructed wedge A 986a with second unobstructed wedge B 984b, may replace first obstructed wedge B 982b with first unobstructed wedge A 980a and/or may replace second obstructed wedge B 986b with second unobstructed wedge A 984a. It should be noted that additional and/or alternative obstructed ranges may be replaced with corresponding unobstructed ranges.

In some configurations, this replacement approach may be performed in conjunction with the hemiellipsoid interchange approach described in connection with FIGS. 3-6. For example, upon interchanging the hemiellipsoids as described above, obstructed image wedges may be replaced with corresponding unobstructed image wedges.

FIG. 9B illustrates an example of the hemiellipsoids 978a-b after replacing obstructed wedges with unobstructed wedges 980a-b, 984a-b as described in connection with FIG. 9A. It should be noted that image wedge replacement may result in stitching (e.g., relatively minor or minimal stitching). For example, there may be stitching between different hatching areas as illustrated by the dashed lines in FIG. 9B.

FIG. 9C is a diagram illustrating an example of a surround view that includes at least one stereoscopic view range 988a-b and at least one monoscopic view range 990a-b. For example, the wedge replacement approach described in connection with FIGS. 9A-9B may be described as switching between one or more stereoscopic views 988a-b (that may cover most of the field of view, for instance) and one or more monoscopic views 990a-b at angles (near an axis 992, for instance).

As illustrated in FIG. 9C, the apparatus 302 may provide (e.g., render) a surround view based on a combination of at least one stereoscopic view range 988a-b and at least one monoscopic view range 990a-b. For example, the apparatus 302 may render a stereoscopic view in stereoscopic view range A 988a and/or in stereoscopic view range B 988b. Additionally, the apparatus 302 may render a monoscopic view in monoscopic view range A 990a and/or in monoscopic view range B 990b. The monoscopic view range A 990a and/or the monoscopic view range B 990b may be angular ranges relative to the axis 992. In some configurations, the monoscopic view range(s) 990a-b may range over the axis. It should be noted that the replacement approach (e.g., monoscopic and stereoscopic hybrid approach) may be performed in the context of native mapping (and not in the context of view synthesis, for example) in some configurations.

When a viewpoint direction is straight ahead (e.g., perpendicular to the axis 992 at the origin), the rendered view may be stereoscopic, which may provide an appearance of depth to the view. However, when the viewpoint direction is turned to right or to the left near the axis 992, the rendered view may switch to a monoscopic view, in order to avoid the appearance of one or more obstructing lenses in the view. It should be noted that the monoscopic view range(s) may include a range in which (e.g., a range that is greater than or equal to a range in which) an obstructing fisheye lens would appear. The surround view (e.g., the full surround view ranging over 360 degrees in both horizontal and vertical angles) may accordingly include one or more stereoscopic view ranges 988a-b and one or more monoscopic view ranges 988b.

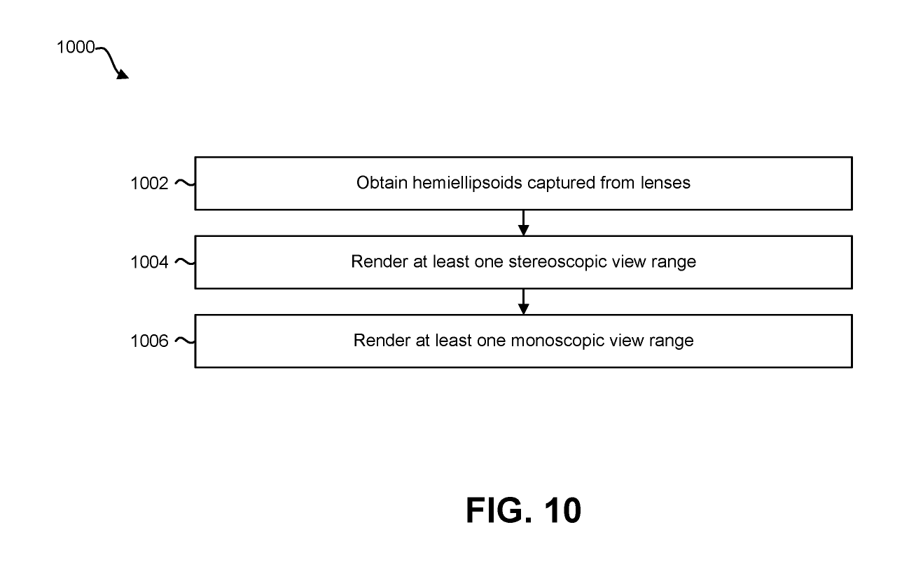

FIG. 10 is a flow diagram illustrating an example of one configuration of a method 1000 for rendering a surround view with at least one stereoscopic view range and at least one monoscopic view range. The method 1000 may be performed by one or more of the apparatuses 102, 202, 302 described herein (e.g., the apparatus 202 described in connection with FIG. 2 and/or the apparatus 302 described in connection with FIG. 3).

The apparatus 302 may obtain 1002 hemiellipsoids obtained (e.g., captured) from lenses (e.g., fisheye lenses). This may be accomplished as described in connection with one or more of FIGS. 1-3 and 5-8.

The apparatus 302 may render 1004 at least one stereoscopic view range. This may be accomplished as described in connection with one or more of FIGS. 9A-9C. For example, the stereoscopic view may be rendered in a range in which an obstructing lens does not appear in at least two lenses (e.g., fisheye lenses).

The apparatus 302 may render 1006 at least one monoscopic view range. This may be accomplished as described in connection with one or more of FIGS. 9A-9C. For example, the monoscopic view may be rendered in a range in which an obstructing lens appears (or would appear) in a hemiellipsoid. It should be noted that rendering 1004 the at least one stereoscopic view range and rendering 1006 the at least one monoscopic view range may be performed as part of rendering a surround view. For example, the surround view may include at least one stereoscopic view range and at least one monoscopic view range.

The apparatus 302 may provide the surround view. This may be accomplished as described in connection with FIG. 3. For example, the apparatus 302 (e.g., processor 320) may provide the surround view to one or more displays on the device and/or may send the surround view to another device. Additionally or alternatively, the apparatus 302 may provide a portion of the surround view (e.g., a portion in a currently viewable range based on a current viewing direction).

One issue that may arise when rendering a surround view that includes a stereoscopic view range and a monoscopic view range is a hard transition between the stereoscopic view range and the monoscopic view range. In some configurations, the apparatus 302 may perform a fade between the at least one stereoscopic view range and the at least one monoscopic view range. For example, the apparatus 302 may fade out one hemiellipsoid that includes the obstruction while fading in the replacement hemiellipsoid in a range transitioning from the stereoscopic view range to the monoscopic view range. For instance, an unobstructed wedge may be larger than the obstructed range in order to allow some overlap for fading and/or blending near the obstructed range. Additionally or alternatively, the apparatus 302 may fade out one or more monoscopic hemiellipsoids while fading in a stereoscopic hemiellipsoid in a range transitioning from the monoscopic view range to the stereoscopic view range. In some approaches, the fade may be performed in a portion of the stereoscopic view range and/or the monoscopic view range. For example, the fade may occur in a buffer region between the stereoscopic view range and the monoscopic view range.

In some configurations, the apparatus 302 may blend the at least one stereoscopic view range and the at least one monoscopic view range. For example, the apparatus 302 may blend the monoscopic view range with the stereoscopic view range in a range transitioning from the stereoscopic view range to the monoscopic view range and/or in a range transitioning from the monoscopic view range to the stereoscopic view range. In some approaches, the blend may be performed in a portion of the stereoscopic view range and/or the monoscopic view range. For example, the blend may occur in a buffer region between the stereoscopic view range and the monoscopic view range. In some configurations, the blend may be a weighted blend. The fade-in/fade-out approach and/or the blend (e.g., weighted blend) approach may help provide a softer transition between monoscopic and stereoscopic view regions.

The systems and methods disclosed herein may ameliorate one or more of the following issues that may occur when producing a stereoscopic surround image and/or video. Some approaches have large form factors that require a large distance between lenses/fisheye lenses and/or only produce monoscopic (no depth) surround images. During rendering of stereoscopic image, the look direction may affect the 2D-plane depth of focus. For example, looking straight ahead may produce a depth of focus at one depth. As the viewpoint direction looks at an angle to the left (relative to straight ahead), the focus depth shifts so that the 2D scene appears closer. If the viewpoint direction looks to the right, the focus depth shifts so that the 2D scene appears farther away. Without modification of capture procedures, when the user looks to the side (to view rendered stereoscopic image) where the other fisheye lens pair is located at an oblique angle, the other fisheye lens pair gets captured in the resulting captured stereoscopic image. When switching between monoscopic and stereoscopic views, there may be a hard transition.

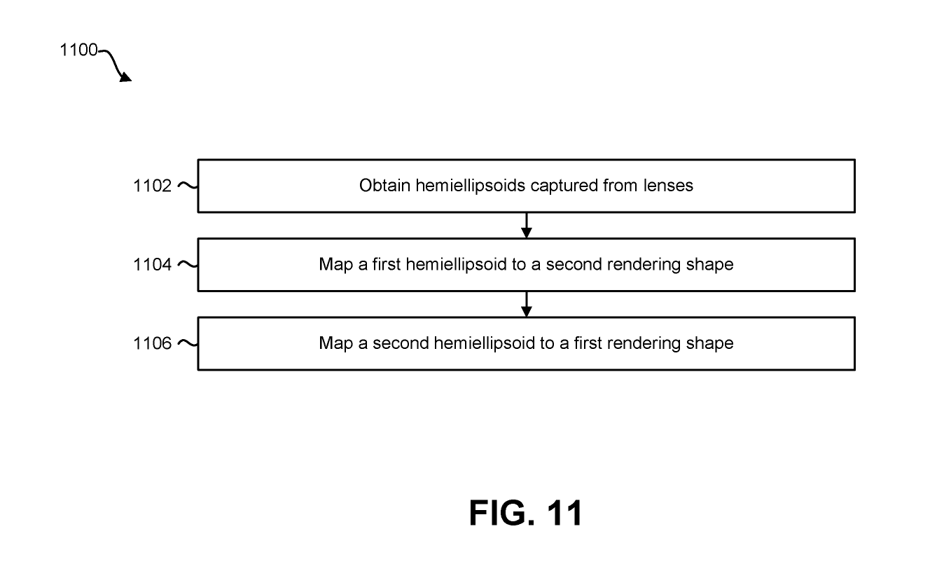

FIG. 11 is a flow diagram illustrating one configuration of a method 1100 for interchanging hemiellipsoids. For example, FIG. 11 may described a method 1100 for avoiding reverse stereoscopic parallax based on an interchange of images corresponding to different lens pairs between a first rendering shape (e.g., first ellipsoid view) and a second rendering shape (e.g., second ellipsoid view). The method 1100 may be performed by one or more of the apparatuses 102, 202, 302 described herein (e.g., the apparatus 202 described in connection with FIG. 2 and/or the apparatus 302 described in connection with FIG. 3). The apparatus 302 may obtain 1102 hemiellipsoids captured from lenses (e.g., fisheye lenses). This may be accomplished as described in connection with one or more of FIGS. 1-3 and 5.

The apparatus 302 may map 1104 (e.g., natively map) a hemiellipsoid to a rendering shape. For example, the apparatus 302 may map 1104 image data from a lens (e.g., the second fisheye lens corresponding to a first fisheye lens pair) to a rendering shape (e.g., a second rendering shape corresponding to a second fisheye lens pair). This may be accomplished as described in connection with one or more of FIGS. 3 and 5.

The apparatus 302 may map 1106 (e.g., natively map) another hemiellipsoid to another rendering shape. For example, the apparatus 302 may map 1106 image data from another lens (e.g., the fourth fisheye lens corresponding to a second fisheye lens pair) to another rendering shape (e.g., a first rendering shape corresponding to a first fisheye lens pair). This may be accomplished as described in connection with one or more of FIGS. 3 and 5.

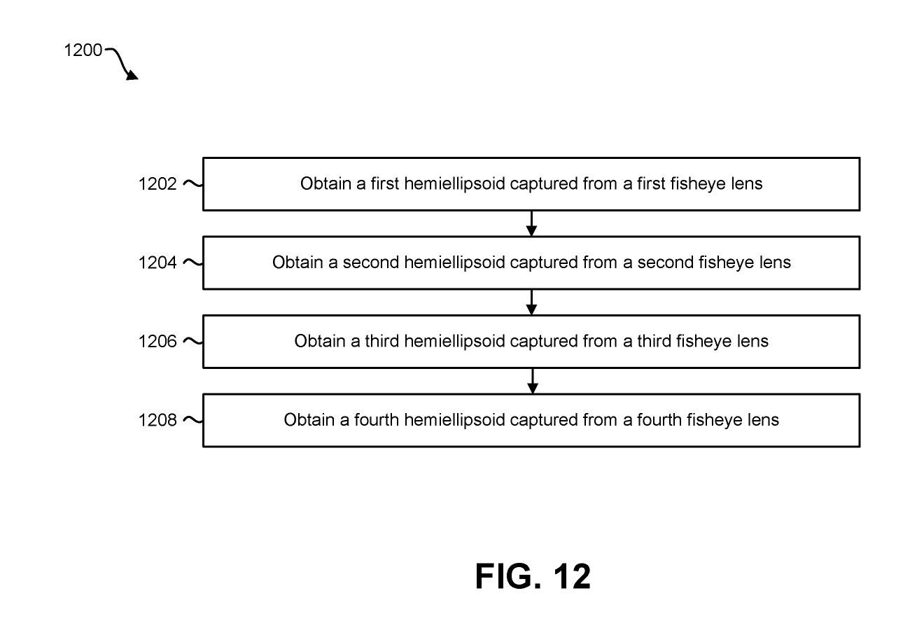

FIG. 12 is flow diagram illustrating one configuration of a method 1200 for obtaining hemiellipsoids. The method 1200 may be performed by one or more of the apparatuses 102, 202, 302 described herein. The apparatus 302 may obtain 1202 a first hemiellipsoid captured from a first fisheye lens. For example, the apparatus 302 may capture an image with a first fisheye lens (e.g., fisheye camera) that is coupled to (e.g., included in) the apparatus 302. Alternatively, the apparatus 302 may receive an image from another device, where the image was captured with a first fisheye lens (e.g., fisheye camera). This may be accomplished as described above in connection with one or more of FIGS. 1-3. It should be noted that the first fisheye lens may be oriented in a first direction (e.g., approximately perpendicular to the base or mounting axis of the first fisheye lens). The first fisheye lens may be one fisheye lens in a pair of fisheye lenses (e.g., one of a double fisheye lens).

The apparatus 302 may obtain 1204 a second hemiellipsoid captured from a second fisheye lens. For example, the apparatus 302 may capture an image with a second fisheye lens (e.g., fisheye camera) that is coupled to (e.g., included in) the apparatus 302. Alternatively, the apparatus 302 may receive an image from another device, where the image was captured with a second fisheye lens (e.g., fisheye camera). This may be accomplished as described above in connection with one or more of FIGS. 1-3. It should be noted that the second fisheye lens may be oriented in a second direction (e.g., approximately opposite from the first direction). The second fisheye lens may be one fisheye lens in a pair of fisheye lenses (e.g., one of a double fisheye lens). The first fisheye lens and the second fisheye lens may be mounted next to each other on approximately the same axis.

The apparatus 302 may obtain 1206 a third hemiellipsoid captured from a third fisheye lens. For example, the apparatus 302 may capture an image with a third fisheye lens (e.g., fisheye camera) that is coupled to (e.g., included in) the apparatus 302. Alternatively, the apparatus 302 may receive an image from another device, where the image was captured with a third fisheye lens (e.g., fisheye camera). This may be accomplished as described above in connection with one or more of FIGS. 1-3. It should be noted that the third fisheye lens may be oriented in a third direction (e.g., approximately perpendicular to the base or mounting axis of the third fisheye lens and/or in approximately the first direction). The third fisheye lens may be one fisheye lens in a pair of fisheye lenses (e.g., one of a double fisheye lens).

The apparatus 302 may obtain 1208 a fourth hemiellipsoid captured from a fourth fisheye lens. For example, the apparatus 302 may capture an image with a fourth fisheye lens (e.g., fisheye camera) that is coupled to (e.g., included in) the apparatus 302. Alternatively, the apparatus 302 may receive an image from another device, where the image was captured with a fourth fisheye lens (e.g., fisheye camera). This may be accomplished as described above in connection with one or more of FIGS. 1-3. It should be noted that the fourth fisheye lens may be oriented in a fourth direction (e.g., approximately opposite from the third direction). The fourth fisheye lens may be one fisheye lens in a pair of fisheye lenses (e.g., one of a double fisheye lens). The third fisheye lens and the fourth fisheye lens may be mounted next to each other on approximately the same axis.

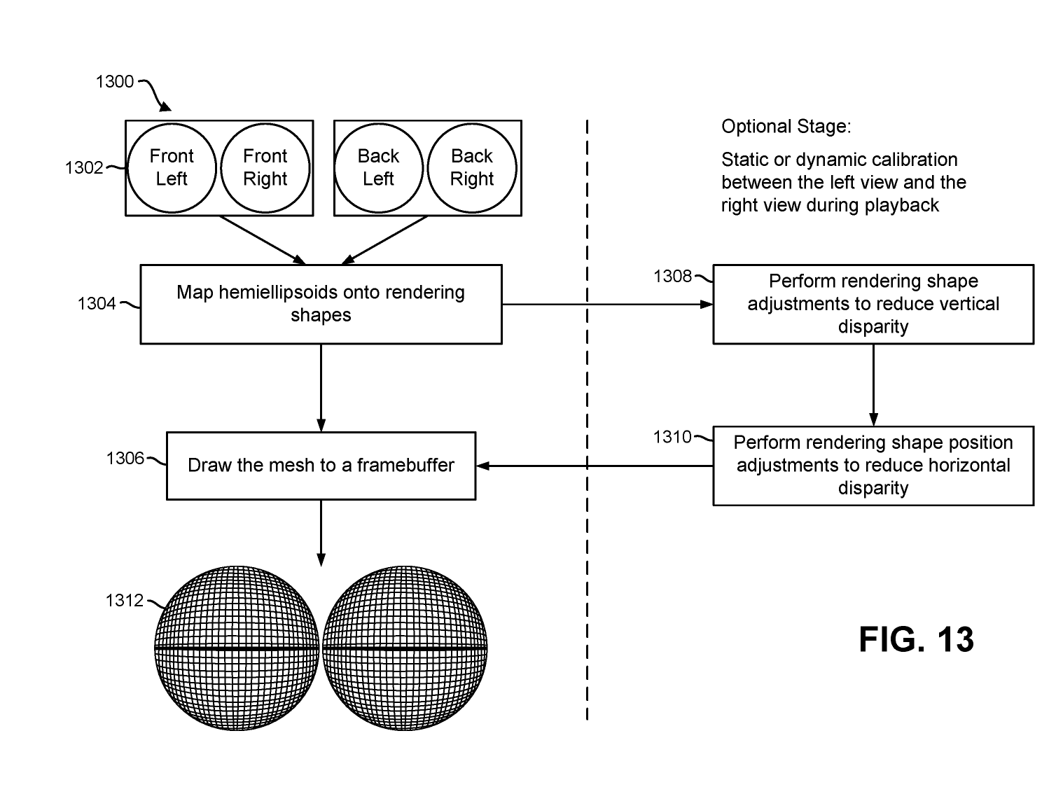

FIG. 13 is a diagram illustrating a functional approach for surround view playback. The procedures for playback described in connection with FIG. 13 may be performed by one or more of the apparatuses 102, 202, 302 described herein (e.g., the apparatus 202 described in connection with FIG. 2, the apparatus 302 described in connection with FIG. 3 or another apparatus).

The apparatus 302 may obtain 1302 hemiellipsoids. This may be accomplished as described in connection with FIG. 3. The apparatus 302 may map 1304 the hemiellipsoids onto one or more shapes. For example, the apparatus 302 may natively map 1304 the hemiellipsoids onto rendering shapes (e.g., ellipsoids). In some configurations, the apparatus 302 may unwarp and/or register the hemiellipsoids on rendering shape(s) (e.g., sphere(s), ellipsoid(s), etc.). For example, the apparatus 302 may perform image registration on sphere UV texture coordinates. The apparatus 302 may draw 1306 a mesh 1312 (e.g., a mesh corresponding to the rendering shapes) to a frame buffer. As illustrated in FIG. 13, no disparity adjustments may be performed in some configurations.

The apparatus 302 may optionally perform static or dynamic calibration between the left view and right view during playback. For example, the apparatus 302 may perform 1308 rendering shape (e.g., ellipsoid, sphere, etc.) adjustments in order to reduce a vertical disparity between images. For instance, the apparatus 302 may perform sphere UV adjustments to reduce vertical disparity. Additionally or alternatively, the apparatus 302 may perform 1310 rendering shape (e.g., ellipsoid, sphere, etc.) position adjustments to reduce a horizontal disparity. For instance, the apparatus 302 may perform sphere position adjustments to reduce horizontal disparity. The apparatus 302 may draw 1306 the mesh 1312 to a frame buffer. The frame buffer may be provided to one or more displays for presentation.

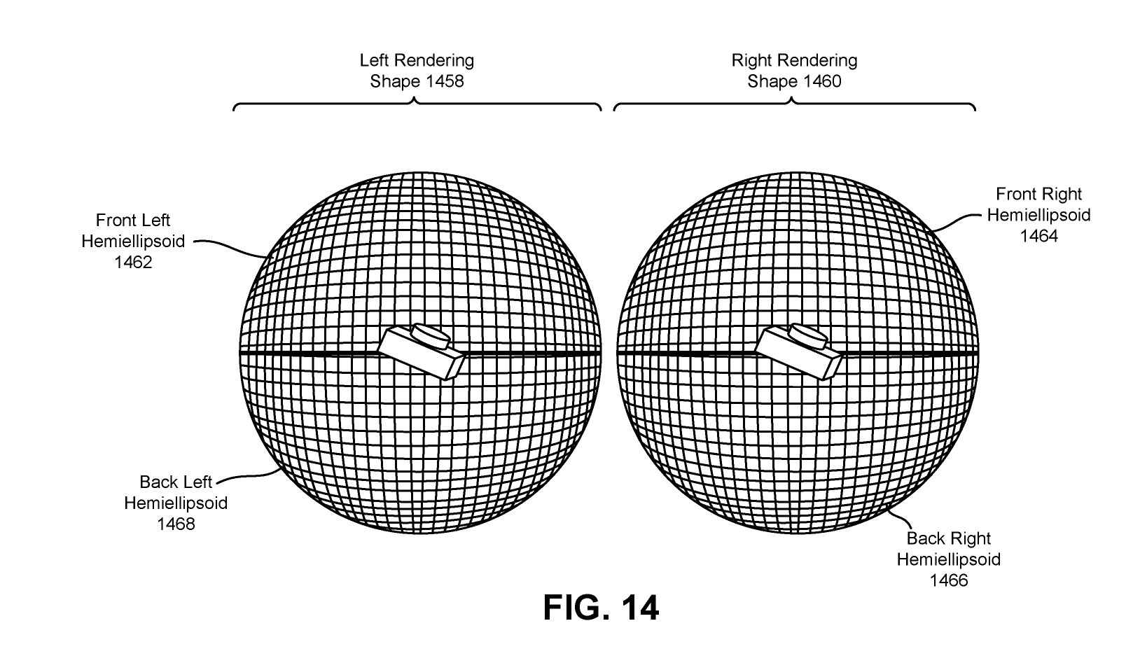

FIG. 14 is a diagram illustrating one example of surround view (e.g., stereoscopic surround view) playback. Surround view (e.g., a view that includes a 360 degree range in both horizontal and vertical directions) can be done on a virtual reality (VR) device (e.g., Google Cardboard) or on a 3D capable device (e.g., 3D TV) in some approaches. In some configurations, surround view playback may be based on 3D graphics rendering of a virtual ellipsoid (e.g., sphere) with the surround view image or video as textures.

During playback of a surround view scene, rendering may be located inside the virtual sphere with textures on its inner wall. The viewpoint may be within the virtual ellipsoid (e.g., sphere). For example, the cameras illustrated in the center of the left rendering shape 1458 and the right rendering shape 1460 in FIG. 14 may illustrate an example of viewing origins in the left rendering shape 1458 and the right rendering shape 1460. The textures are the images or videos captured as described above. It should be noted that the surround view may be captured, rendered and/or played back on the same device or on different devices.

For the left rendering shape 1458 (e.g., the left view), the textures may be the front left hemiellipsoid 1462 and the back left hemiellipsoid 1468 (e.g., images captured by the front left lens and the back left lens, respectively). Each lens may cover frontal half and the back half of the ellipsoid (e.g., sphere). For the right rendering shape 1460 (e.g., the right view), the textures may be the front right hemiellipsoid 1464 and the back right hemiellipsoid 1466 (e.g., images captured by the front right lens and the back right lens, respectively). Each lens may cover frontal half and the back half of the sphere. Each lens may cover the frontal half and back half of the ellipsoid (e.g., sphere).

During rendering, the viewing direction may be adjusted according to sensors (e.g., gyro, accelerometers, etc.) in three degrees of freedom (3DOF) of rotation on the viewing device. During rendering, the viewpoint location may be adjusted according to moving forward command for zoom-in and/or moving backward command for zoom-out.

Both left and right viewing directions may be in sync. Both left and right image and video playing may be in sync. Both front and back image and video playing may be in sync.

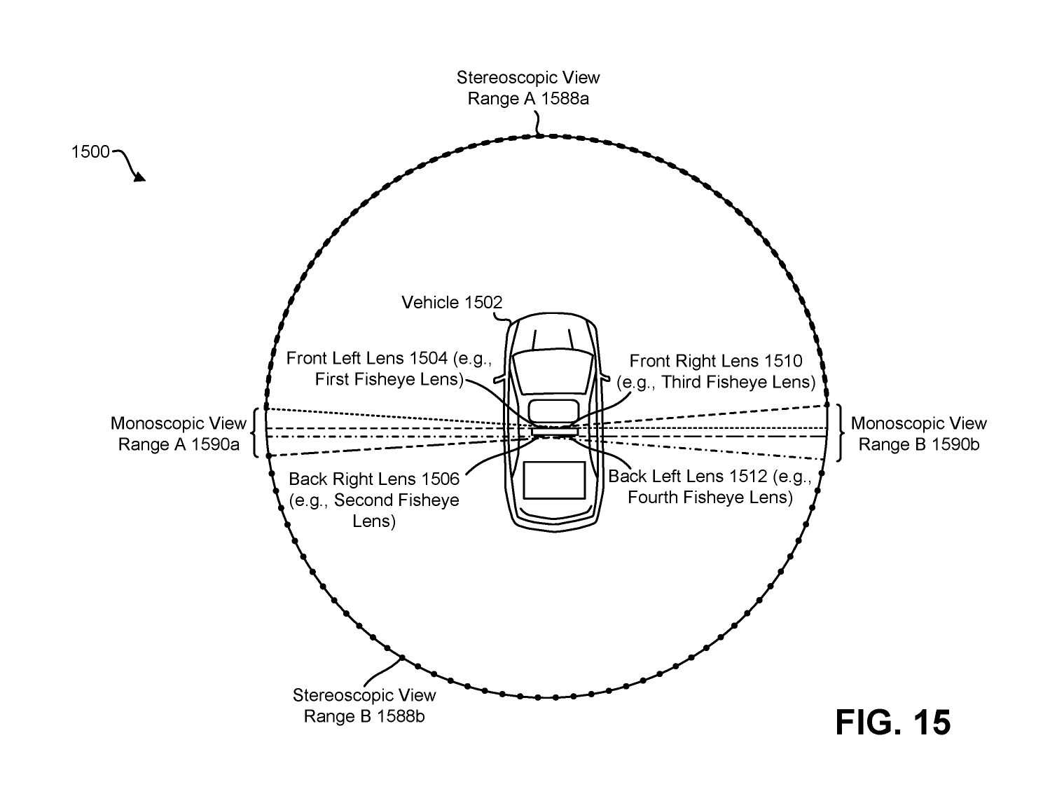

FIG. 15 is a diagram illustrating an example of a configuration of the systems and methods disclosed herein. In particular, FIG. 15 illustrates a surround view 1500 in relation to a vehicle 1502. The vehicle 1502 may be an example of one or more of the apparatuses 102, 202, 302 described herein. As illustrated in FIG. 15, several lenses 1504, 1506, 1510 1512 may be coupled to the vehicle 1502.

In this example, a front left lens 1504, a back right lens 1506, a front right lens 1510 and a back left lens 1512 are coupled to the top of the vehicle 1502. The vehicle 1502 (e.g., an electronic device included in the vehicle 1502) may capture hemiellipsoids from the lenses 1504, 1506, 1510 1512 and render the surround view 1500 based on the hemiellipsoids. In this example, hemiellipsoid ranges showing obstructing lenses may be replaced with unobstructed ranges of the hemiellipsoids as described herein (e.g., as described in connection with one or more of FIGS. 9A-C). This approach results in the surround view 1500 including stereoscopic view range A 1588a, stereoscopic view range B 1588b, monoscopic view range A 1590a and monoscopic view range B 1590b.

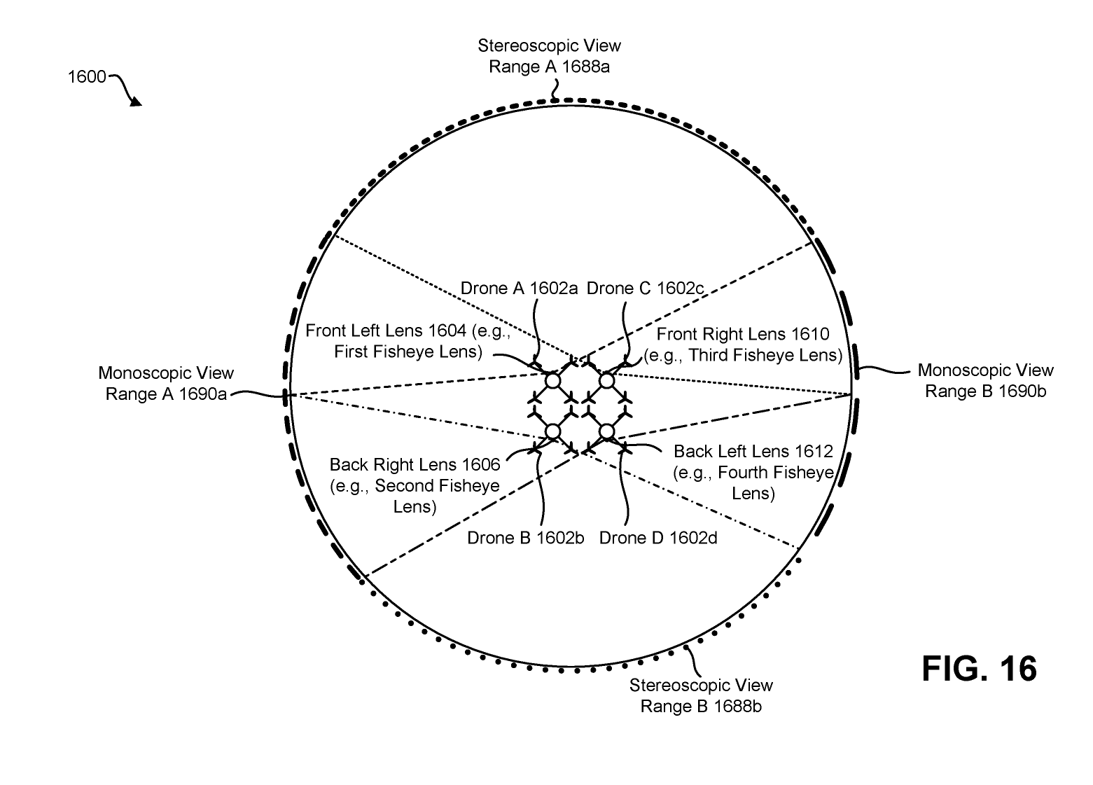

FIG. 16 is a diagram illustrating another example of a configuration of the systems and methods disclosed herein. In particular, FIG. 16 illustrates a surround view 1600 in relation to a group of drones 1602a-d. The drones 1602a-d may be examples of one or more of the apparatuses 102, 202, 302 described herein. As illustrated in FIG. 16, a lens 1604, 1606, 1610 1612 may be coupled to each of the drones 1602a-d.

In this example, a front left lens 1604 is coupled to drone A 1602a, a back right lens 1606 is coupled to drone B 1602b, a front right lens 1610 is coupled to drone C 1602c and a back left lens 1612 is coupled to drone 1602d. The drones 1602a-d may capture hemiellipsoids from the lenses 1604, 1606, 1610 1612 and/or one or more of the drones 1602a-d may render the surround view 1600 based on the hemiellipsoids. In this example, hemiellipsoid ranges showing obstructing drones may be replaced with unobstructed ranges of the hemiellipsoids as described herein (e.g., as described in connection with one or more of FIGS. 9A-C). This approach results in the surround view 1600 including stereoscopic view range A 1688a, stereoscopic view range B 1688b, monoscopic view range A 1690a and monoscopic view range B 1690b.

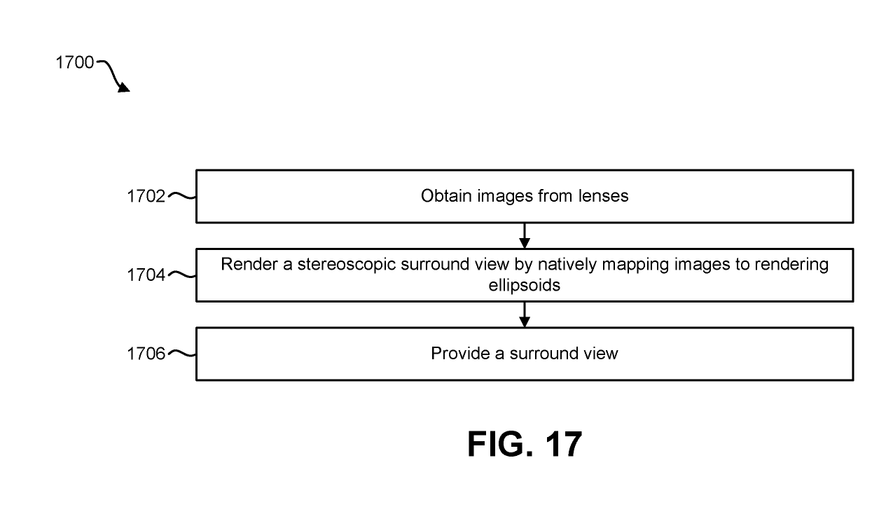

FIG. 17 is a flow diagram illustrating one configuration of a method 1700 for avoiding an obstruction (e.g., obstructing lens) in a stereoscopic surround view. The method 1700 may be performed by one or more of the apparatuses 102, 202, 302 described in connection with one or more FIGS. 1-3. The apparatus 302 may obtain 1702 images (e.g., hemiellipsoids) from lenses (e.g., fisheye lenses). This may be accomplished as described in connection with one or more of FIGS. 1-3 and 5. For example, the apparatus 302 may obtain 1702 a plurality of images from a plurality of lenses. One or more of the lenses may have fields of view larger than 180 degrees (e.g., 220 degrees, 240 degrees, etc.) in some configurations.

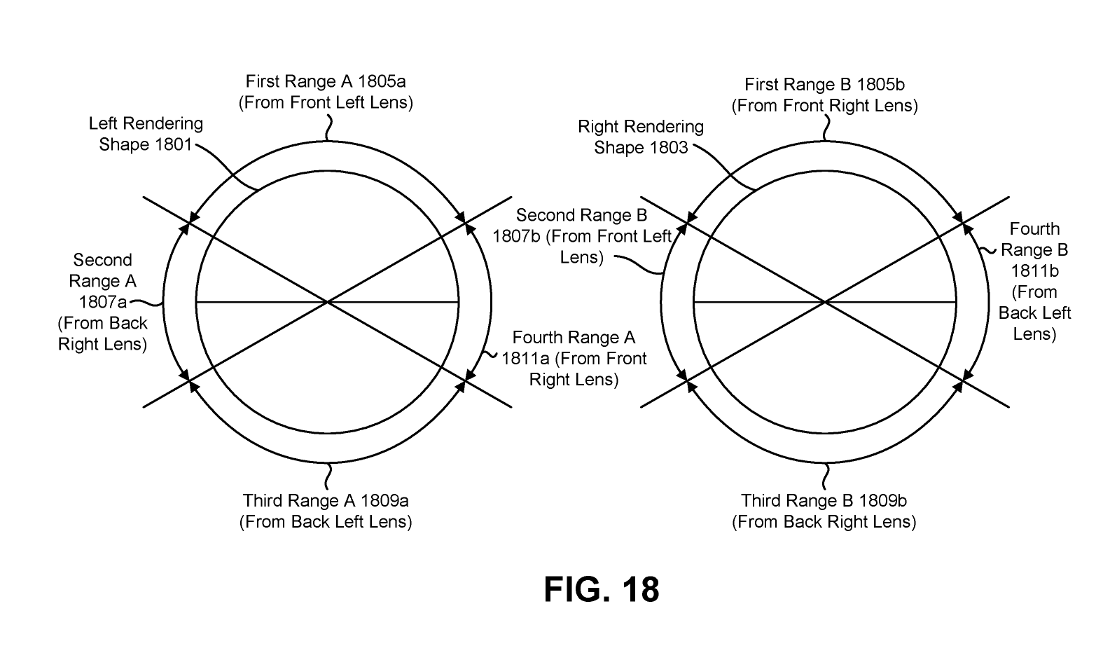

The apparatus 302 may render 1704 a stereoscopic surround view by natively mapping images to rendering ellipsoids. For example, the apparatus 302 may avoid an obstruction (e.g., an obstructing lens) based on rendering 1704 a stereoscopic surround view. The stereoscopic surround view may include a first rendering shape (e.g., ellipsoid, sphere, etc.) and a second rendering shape (e.g., ellipsoid, sphere, etc.). Rendering 1704 the stereoscopic surround view may include natively mapping a first image (e.g., an image from a first lens, a first hemiellipsoid, etc.) to a first range of the first rendering shape and natively mapping the first image to a second range of the second rendering shape. For instance, the first image (e.g., different ranges of the first image) may be mapped to different ranges of the first rendering shape and the second rendering shape. In some configurations, different mappings (e.g., interchanging between lens pairs, image swapping, etc.) may be applied to different view ranges (e.g., facing frontwards, facing backwards, etc.). An example of rendering 1704 the stereoscopic surround view is given in connection with FIG. 18.

In a more specific example, the apparatus 302 may remove an obstruction in the field of view of a first lens (captured by a stereoscopic pair of lenses located in the same plane, for instance). This may be accomplished by mapping (e.g., swapping, interchanging, etc.) image ranges between stereoscopic lens pairs. In some configurations, the mapping may be based on a view orientation (e.g., head orientation). For example, a different mapping may be performed when the view is to the back versus the mapping that is performed when the view is to the front.

In some configurations, rendering 1704 the stereoscopic surround view may avoid reverse stereoscopic parallax. For example, the plurality of images may be natively mapped to the rendering shapes (e.g., ellipsoids). The plurality of images may be natively mapped to different ranges of the rendering shapes (e.g., ellipsoids).

The apparatus 302 may provide 1706 the surround view. This may be accomplished as described in connection with FIG. 3. For example, the apparatus 302 (e.g., processor 320) may provide the surround view to one or more displays on the apparatus and/or may send the surround view to another apparatus or device.

FIG. 18 is a diagram illustrating an example of rendering shapes 1801, 1803 that may be rendered to produce a stereoscopic surround view. In this example, each of the rendering shapes 1801, 1803 includes four ranges. For example, the left rendering shape 1801 includes first range A 1805a, second range A 1807a, third range A 1809a and fourth range A 1811a. The right rendering shape 1803 includes first range B 1805b, second range B 1807b, third range B 1809b and fourth range B 1811b. It should be noted that corresponding ranges (e.g., first range A 1805a and first range B 1805b, etc.) may or may not have the same span (e.g., angle). In some cases, obstructions may be captured in one or more of the range(s) of the captured images. For example, an image from a front left lens may include an obstruction (e.g., obstructing lens) in fourth range A 1811a, etc. In some cases, this may be similar to the situation described is connection with FIG. 8.

In some configurations of the systems and methods disclosed herein, a full stereoscopic surround view may be achieved. For example, each of the lenses of the apparatus 302 may have fields of view greater than 180 degrees. This may allow for overlapping coverage by at least two lenses in a full 360 rotation. In an example where each of the lenses has a 240-degree field of view, approximately 60 degrees of overlap may be achieved when mounting the lenses back-to-back.

In order to avoid reverse stereoscopic parallax and/or obstructions, images from each of the lenses may be mapped to different portions of each of the rendering shapes 1801, 1803. In the example illustrated in FIG. 18, an image (e.g., hemiellipsoid) from the front left lens may be mapped (e.g., natively mapped) to first range A 1805a and to second range B 1807b. Additionally or alternatively, an image (e.g., hemiellipsoid) from the back right lens may be mapped (e.g., natively mapped) to second range A 1807a and to third range B 1809b. Additionally or alternatively, an image (e.g., hemiellipsoid) from the back left lens may be mapped (e.g., natively mapped) to third range A 1809a and to fourth range B 1811b. Additionally or alternatively, an image (e.g., hemiellipsoid) from the front right lens may be mapped (e.g., natively mapped) to fourth range A 1811a and to first range B 1805b.

The native mapping may avoid obstructions (e.g., obstructing lenses). For example, in those ranges where an obstruction is shown in an image from a particular lens, an image without the obstruction from a different lens may be mapped to the rendering shape. Because there is sufficient overlap between the images from each of the lenses, a stereoscopic view may be achieved in the entire surround view.

It should be noted that different lenses (e.g., cameras) may be coupled to and/or mounted on a variety of objects and/or devices (e.g., cars, drones, etc.) in a variety of locations. If an apparatus (e.g., apparatus 302) is streaming out data in a single (video) frame, images may be copied (e.g., swapped) to the appropriate eye. If this is not done, a user may perceive reverse stereoscopic parallax. Other approaches (which produce a monoscopic view in front and back, for example) do not encounter this issue. However, when two lenses are placed side-by-side, the view may no longer be just a monoscopic view from front to back, but a pair of views facing the front and another pair of views facing the back. Accordingly, for an apparatus (e.g., vehicle, smartphone, etc.) that produces a stereoscopic view, the streamed data may need to be mapped to the appropriate eye for whatever viewing direction the user is viewing.

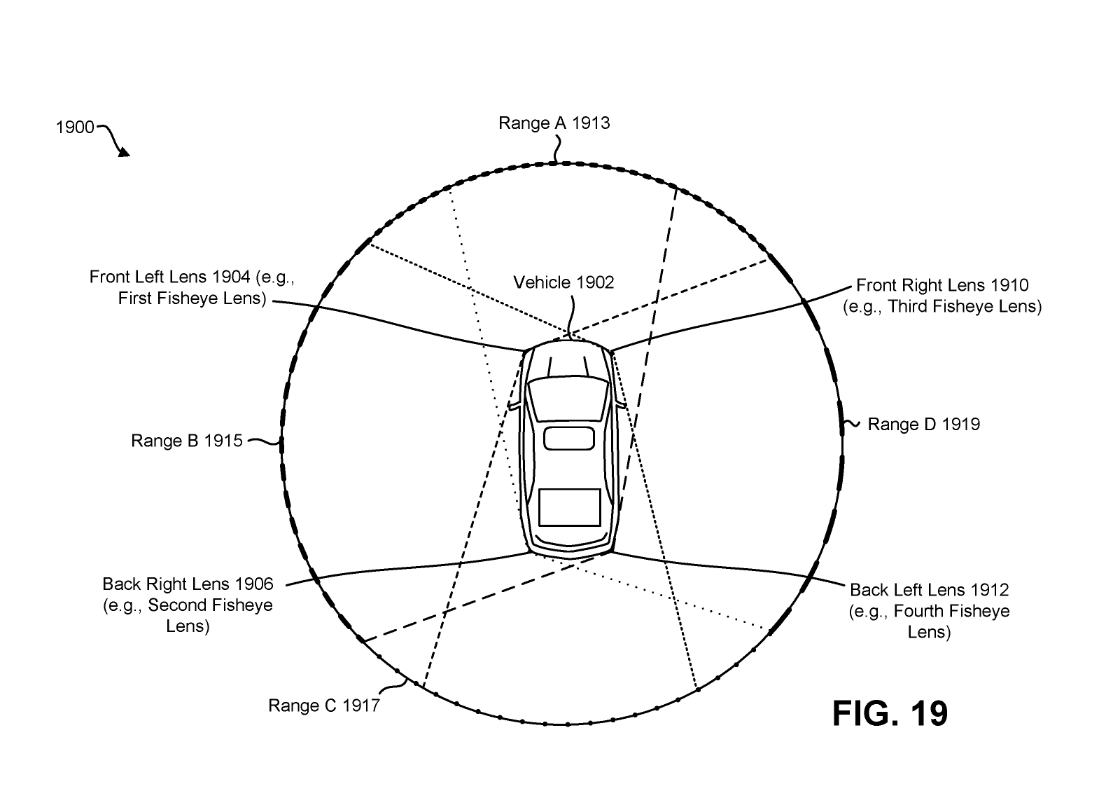

FIG. 19 is a diagram illustrating another example of a configuration of the systems and methods disclosed herein. In particular, FIG. 19 illustrates a stereoscopic surround view 1900 in relation to a vehicle 1902. The vehicle 1902 may be an example of one or more of the apparatuses 102, 202, 302 described herein. As illustrated in FIG. 19, several lenses 1904, 1906, 1910, 1912 may be coupled to the vehicle 1902. Each of the lenses 1904, 1906, 1910, 1912 may have a field of view greater than 180 degrees. In this example, each field of view boundary is shown with a dashed or dotted line originating from each respective lens 1904, 1906, 1910, 1912. As can be observed in FIG. 19, at least two fields of view may cover each viewing direction.

In this example, a front left lens 1904, a back right lens 1906, a front right lens 1910 and a back left lens 1912 are coupled to the corners of the vehicle 1902. The vehicle 1902 (e.g., an electronic device included in the vehicle 1902) may capture images (e.g., hemiellipsoids) from the lenses 1904, 1906, 1910, 1912 and render the surround view 1900 based on the images (e.g., hemiellipsoids). In some configurations, image ranges showing obstructing lenses may be replaced with unobstructed ranges of the images as described herein (e.g., as described in connection with one or more of FIGS. 17-18). This approach results in the stereoscopic surround view 1900.

In this example, range A 1913, range B 1915, range C 1917 and range D 1919 are illustrated. While the ranges 1913, 1915, 1917, 1919 are illustrated as corresponding to lens field of view boundaries, it should be noted that one or more of the ranges 1913, 1915, 1917, 1919 may occupy any range that is covered by at least two fields of view (and may not directly correspond to a field of view boundary, for example). In this example, the stereoscopic surround view in range A 1913 may be produced by natively mapping images from the front left lens 1904 for a left rendering shape and the front right lens 1910 for a right rendering shape. The stereoscopic surround view 1900 in range B 1915 may be produced by natively mapping images from the back right lens 1906 for a left rendering shape and the front left lens 1904 for a right rendering shape. The stereoscopic surround view 1900 in range C 1917 may be produced by natively mapping images from the back left lens 1912 for a left rendering shape and the back right lens 1906 for a right rendering shape. The stereoscopic surround view 1900 in range D 1919 may be produced by natively mapping images from the front right lens 1910 for a left rendering shape and the back left lens 1912 for a right rendering shape.

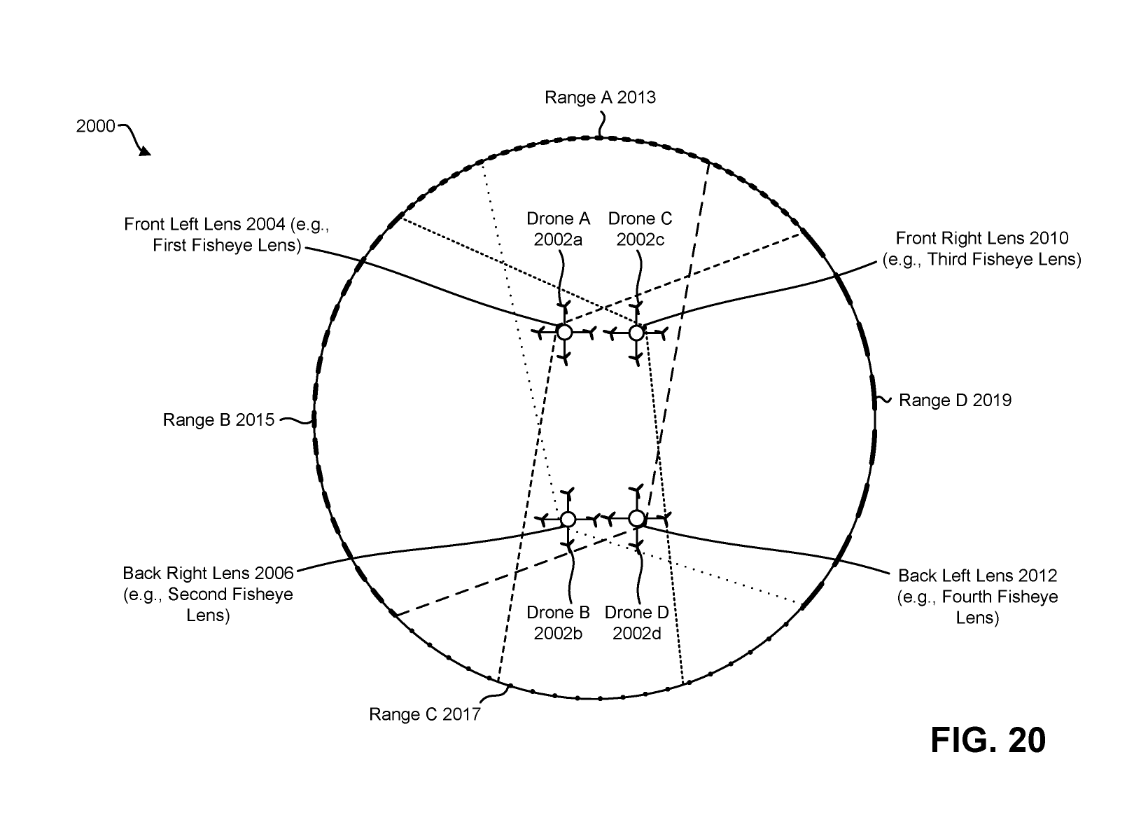

FIG. 20 is a diagram illustrating another example of a configuration of the systems and methods disclosed herein. In particular, FIG. 20 illustrates a stereoscopic surround view 2000 in relation to a group of drones 2002a-d. The drones 2002a-d may be examples of one or more of the apparatuses 102, 202, 302 described herein. As illustrated in FIG. 20, a lens 2004, 2006, 2010, 2012 may be coupled to each of the drones 2002a-d. Each of the lenses 2004, 2006, 2010, 2012 may have a field of view greater than 180 degrees. In this example, each field of view boundary is shown with a dashed or dotted line originating from each respective lens 2004, 2006, 2010, 2012. As can be observed in FIG. 20, at least two fields of view may cover each viewing direction.

In this example, a front left lens 2004 is coupled to drone A 2002a, a back right lens 2006 is coupled to drone B 2002b, a front right lens 2010 is coupled to drone C 2002c and a back left lens 2012 is coupled to drone 2002d. The drones 2002a-d may capture images (e.g., hemiellipsoids) from the lenses 2004, 2006, 2010, 2012 and/or one or more of the drones 2002a-d may render the surround view 2000 based on the images (e.g., hemiellipsoids). In some configurations, image ranges showing obstructions may be replaced with unobstructed ranges of the images as described herein (e.g., as described in connection with one or more of FIGS. 17-18). This approach results in the stereoscopic surround view 2000.

In this example, range A 2013, range B 2015, range C 2017 and range D 2019 are illustrated. While the ranges 2013, 2015, 2017, 2019 are illustrated as corresponding to lens field of view boundaries, it should be noted that one or more of the ranges 2013, 2015, 2017, 2019 may occupy any range that is covered by at least two fields of view (and may not directly correspond to a field of view boundary, for example). In this example, the stereoscopic surround view 2000 in range A 2013 may be produced by natively mapping images from the front left lens 2004 for a left rendering shape and the front right lens 2010 for a right rendering shape. The stereoscopic surround view 2000 in range B 2015 may be produced by natively mapping images from the back right lens 2006 for a left rendering shape and the front left lens 2004 for a right rendering shape. The stereoscopic surround view 2000 in range C 2017 may be produced by natively mapping images from the back left lens 2012 for a left rendering shape and the back right lens 2006 for a right rendering shape. The stereoscopic surround view 2000 in range D 2019 may be produced by natively mapping images from the front right lens 2010 for a left rendering shape and the back left lens 2012 for a right rendering shape.

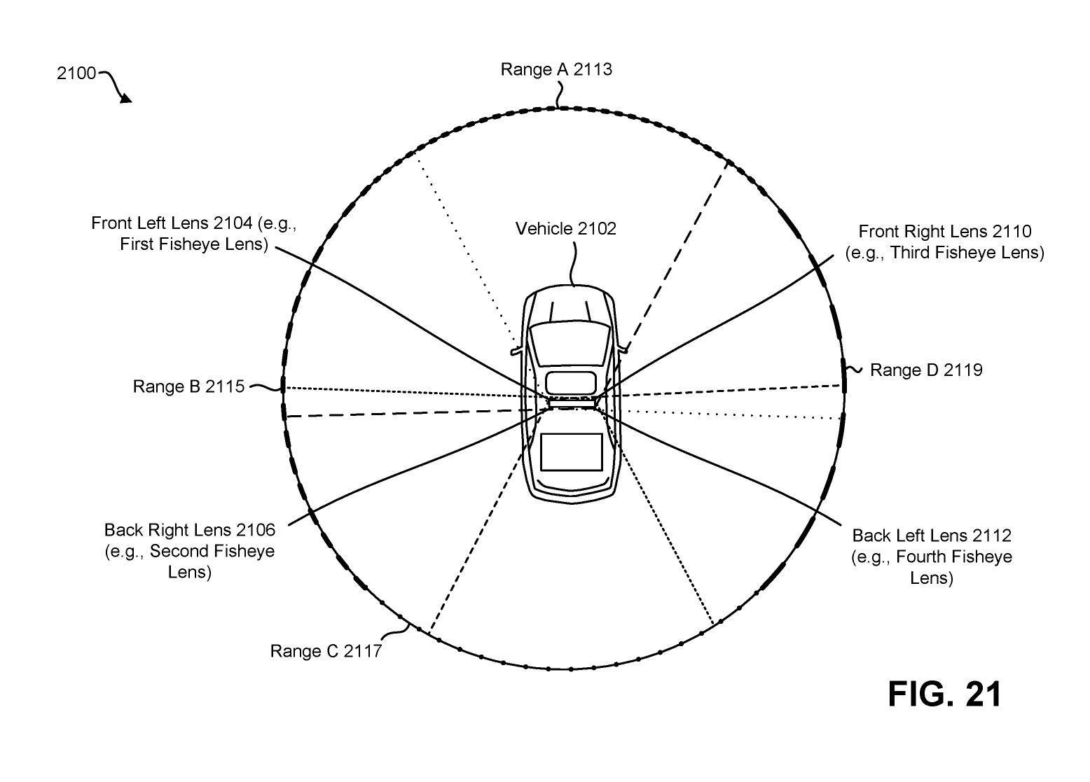

FIG. 21 is a diagram illustrating another example of a configuration of the systems and methods disclosed herein. In particular, FIG. 21 illustrates a stereoscopic surround view 2100 in relation to a vehicle 2102. The vehicle 2102 may be an example of one or more of the apparatuses 102, 202, 302 described herein. As illustrated in FIG. 21, several lenses 2104, 2106, 2110, 2112 may be coupled to the vehicle 2102. Each of the lenses 2104, 2106, 2110, 2112 may have a field of view greater than 180 degrees. In this example, each field of view boundary is shown with a dashed or dotted line originating from each respective lens 2104, 2106, 2110, 2112. As can be observed in FIG. 21, at least two fields of view may cover each viewing direction.

In this example, a front left lens 2104, a back right lens 2106, a front right lens 2110 and a back left lens 2112 are coupled to the top of the vehicle 2102. The vehicle 2102 (e.g., an electronic device included in the vehicle 2102) may capture images (e.g., hemiellipsoids) from the lenses 2104, 2106, 2110, 2112 and render the surround view 2100 based on the images (e.g., hemiellipsoids). In some configurations, image ranges showing obstructing lenses may be replaced with unobstructed ranges of the images as described herein (e.g., as described in connection with one or more of FIGS. 17-18). This approach results in the stereoscopic surround view 2100.

In this example, range A 2113, range B 2115, range C 2117 and range D 2119 are illustrated. The ranges 2113, 2115, 2117, 2119 do not directly correspond to lens field of view boundaries in this example. It should be noted that one or more of the ranges 2113, 2115, 2117, 2119 may occupy any range that is covered by at least two fields of view (and may or may not directly correspond to a field of view boundary, for example). In this example, the stereoscopic surround view in range A 2113 may be produced by natively mapping images from the front left lens 2104 for a left rendering shape and the front right lens 2110 for a right rendering shape. The stereoscopic surround view 2100 in range B 2115 may be produced by natively mapping images from the back right lens 2106 for a left rendering shape and the front left lens 2104 for a right rendering shape. The stereoscopic surround view 2100 in range C 2117 may be produced by natively mapping images from the back left lens 2112 for a left rendering shape and the back right lens 2106 for a right rendering shape. The stereoscopic surround view 2100 in range D 2119 may be produced by natively mapping images from the front right lens 2110 for a left rendering shape and the back left lens 2112 for a right rendering shape. It should be noted that while many of the examples herein are described in terms of four lenses, more or fewer lenses may be implemented in accordance with the systems and methods disclosed herein.

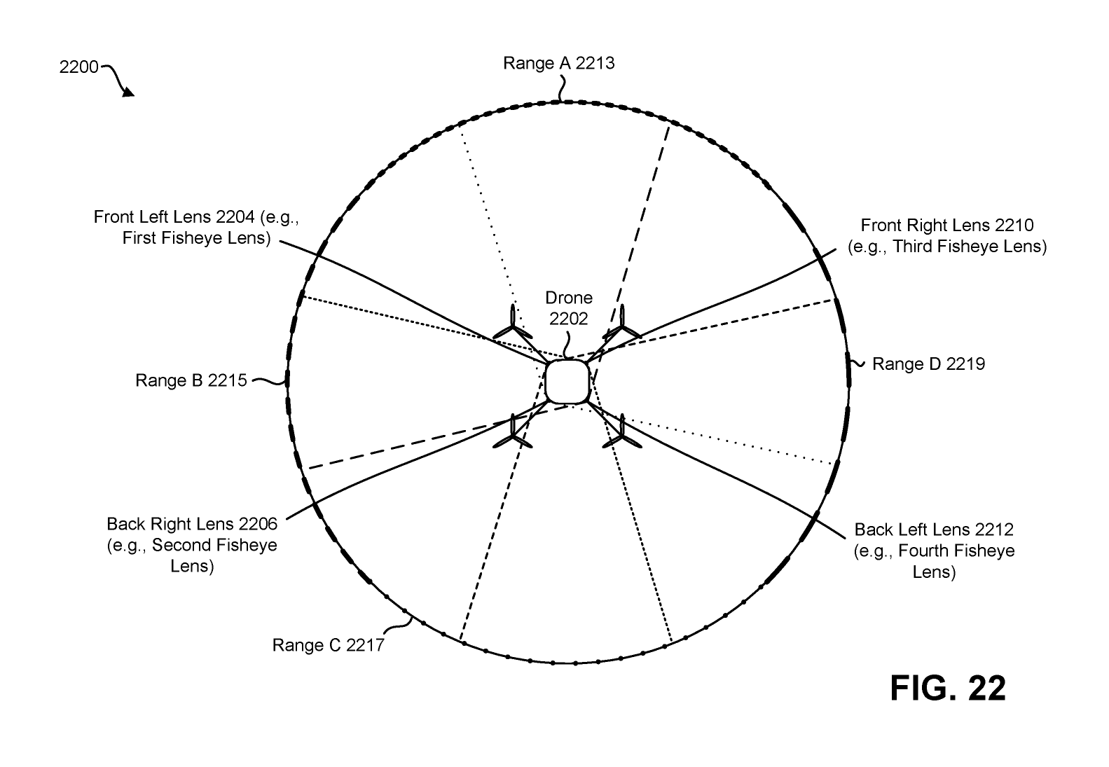

FIG. 22 is a diagram illustrating another example of a configuration of the systems and methods disclosed herein. In particular, FIG. 22 illustrates a stereoscopic surround view 2200 in relation to a drone 2202. The drone 2202 may be an example of one or more of the apparatuses 102, 202, 302 described herein. As illustrated in FIG. 22, several lenses 2204, 2206, 2210, 2212 may be coupled to the drone 2202. Each of the lenses 2204, 2206, 2210, 2212 may have a field of view greater than 180 degrees. In this example, each field of view boundary is shown with a dashed or dotted line originating from each respective lens 2204, 2206, 2210, 2212. As can be observed in FIG. 22, at least two fields of view may cover each viewing direction.

In this example, a front left lens 2204, a back right lens 2206, a front right lens 2210 and a back left lens 2212 are coupled to the corners of the drone 2202. The drone 2202 (e.g., an electronic device included in the drone 2202) may capture images (e.g., hemiellipsoids) from the lenses 2204, 2206, 2210, 2212 and render the surround view 2200 based on the images (e.g., hemiellipsoids). In some configurations, image ranges showing obstructing lenses may be replaced with unobstructed ranges of the images as described herein (e.g., as described in connection with one or more of FIGS. 17-18). This approach results in the stereoscopic surround view 2200.

In this example, range A 2213, range B 2215, range C 2217 and range D 2219 are illustrated. The ranges 2213, 2215, 2217, 2219 do not directly correspond to lens field of view boundaries in this example. It should be noted that one or more of the ranges 2213, 2215, 2217, 2219 may occupy any range that is covered by at least two fields of view (and may or may not directly correspond to a field of view boundary, for example). In this example, the stereoscopic surround view in range A 2213 may be produced by natively mapping images from the front left lens 2204 for a left rendering shape and the front right lens 2210 for a right rendering shape. The stereoscopic surround view 2200 in range B 2215 may be produced by natively mapping images from the back right lens 2206 for a left rendering shape and the front left lens 2204 for a right rendering shape. The stereoscopic surround view 2200 in range C 2217 may be produced by natively mapping images from the back left lens 2212 for a left rendering shape and the back right lens 2206 for a right rendering shape. The stereoscopic surround view 2200 in range D 2219 may be produced by natively mapping images from the front right lens 2210 for a left rendering shape and the back left lens 2212 for a right rendering shape.

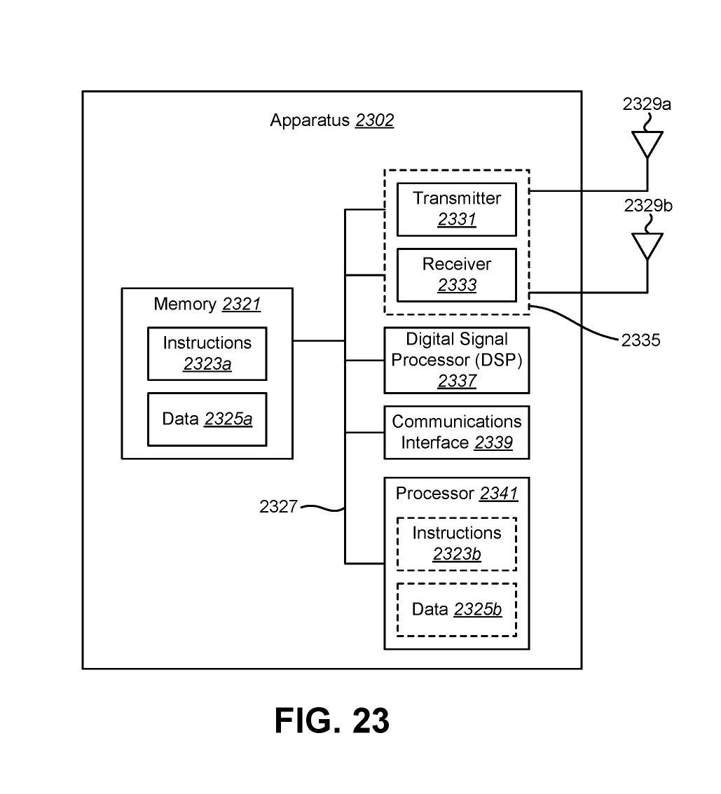

FIG. 23 illustrates certain components that may be included within an apparatus 2302 configured to implement various configurations of the systems and methods disclosed herein. Examples of the apparatus 2302 may include cameras, video camcorders, digital cameras, cellular phones, smart phones, computers (e.g., desktop computers, laptop computers, etc.), tablet devices, media players, televisions, vehicles, automobiles, personal cameras, wearable cameras, virtual reality devices (e.g., headsets), augmented reality devices (e.g., headsets), mixed reality devices (e.g., headsets), action cameras, surveillance cameras, mounted cameras, connected cameras, robots, aircraft, drones, unmanned aerial vehicles (UAVs), smart applications, healthcare equipment, gaming consoles, personal digital assistants (PDAs), set-top boxes, etc. The apparatus 2302 may be implemented in accordance with one or more of the apparatuses 102, 202, 302, vehicles 1502, 1902, 2102 and/or drones 1602, 2002, 2202, etc., described herein.

The apparatus 2302 includes a processor 2341. The processor 2341 may be a general purpose single- or multi-chip microprocessor (e.g., an ARM), a special purpose microprocessor (e.g., a digital signal processor (DSP)), a microcontroller, a programmable gate array, etc. The processor 2341 may be referred to as a central processing unit (CPU). Although just a single processor 2341 is shown in the apparatus 2302, in an alternative configuration, a combination of processors (e.g., an ARM and DSP) could be implemented.

The apparatus 2302 also includes memory 2321. The memory 2321 may be any electronic component capable of storing electronic information. The memory 2321 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 2325a and instructions 2323a may be stored in the memory 2321. The instructions 2323a may be executable by the processor 2341 to implement one or more of the methods 600, 1000, 1100, 1200, 1700, procedures, steps, and/or functions described herein. Executing the instructions 2323a may involve the use of the data 2325a that is stored in the memory 2321. When the processor 2341 executes the instructions 2323, various portions of the instructions 2323b may be loaded onto the processor 2341 and/or various pieces of data 2325b may be loaded onto the processor 2341.

The apparatus 2302 may also include a transmitter 2331 and/or a receiver 2333 to allow transmission and reception of signals to and from the apparatus 2302. The transmitter 2331 and receiver 2333 may be collectively referred to as a transceiver 2335. One or more antennas 2329a-b may be electrically coupled to the transceiver 2335. The apparatus 2302 may also include (not shown) multiple transmitters, multiple receivers, multiple transceivers and/or additional antennas.

The apparatus 2302 may include a digital signal processor (DSP) 2337. The apparatus 2302 may also include a communications interface 2339. The communications interface 2339 may allow and/or enable one or more kinds of input and/or output. For example, the communications interface 2339 may include one or more ports and/or communication devices for linking other devices to the apparatus 2302. In some configurations, the communications interface 2339 may include the transmitter 2331, the receiver 2333, or both (e.g., the transceiver 2335). Additionally or alternatively, the communications interface 2339 may include one or more other interfaces (e.g., touchscreen, keypad, keyboard, microphone, camera, etc.). For example, the communication interface 2339 may enable a user to interact with the apparatus 2302.

The various components of the apparatus 2302 may be coupled together by one or more buses, which may include a power bus, a control signal bus, a status signal bus, a data bus, etc. For the sake of clarity, the various buses are illustrated in FIG. 23 as a bus system 2327.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An apparatus, comprising:
an electronic device configured to provide a surround view based on a combination of at least one stereoscopic view range and at least one monoscopic view range.

2. The apparatus of claim 1, further comprising a plurality of lenses coupled to the apparatus, wherein the lenses are configured to obtain a plurality of images for the at least one stereoscopic view range and the at least monoscopic view range.

3. The apparatus of claim 1, wherein the electronic device is configured to render the at least one monoscopic view range in the surround view without an obstructing lens that is coupled to the apparatus.

4. The apparatus of claim 1, wherein the apparatus is a vehicle, wherein the vehicle comprises a plurality of lenses coupled to the vehicle, wherein the plurality of lenses is configured to obtain the at least one stereoscopic view range used to form the surround view.

5. The apparatus of claim 4, further comprising a display coupled to the vehicle, wherein the display is configured to output the surround view.

6. The apparatus of claim 1, wherein the apparatus is a mobile device, wherein the mobile device comprises a plurality of lenses coupled to the mobile device, wherein at least two of the plurality of lenses are configured to obtain the at least one stereoscopic view range used to form the surround view.

7. The apparatus of claim 1, further comprising a display configured to output the surround view in augmented reality.

8. The apparatus of claim 1, wherein the electronic device is configured to render the surround view, wherein the surround view comprises a first ellipsoid view and a second ellipsoid view.

9. The apparatus of claim 8, further comprising a processor configured to avoid reverse stereoscopic parallax based on an interchange of images corresponding to different lens pairs between the first ellipsoid view and the second ellipsoid view.

10. The apparatus of claim 8, further comprising a processor configured to avoid a realignment of images based on a projection of a plurality of images obtained by a plurality of lenses coupled to the apparatus, wherein the apparatus is a vehicle used in an Advanced Driver Assistance System (ADAS).

11. The apparatus of claim 1, further comprising a processor configured to perform at least one of a fade and a blend in an overlap between at least one of the at least one stereoscopic view range and at least one of the at least one monoscopic view range.

12. An apparatus, comprising:
means for providing a surround view based on a combination of at least one stereoscopic view range and at least one monoscopic view range.

13. The apparatus of claim 12, wherein the means for providing a surround view comprises means for rendering the at least one monoscopic view range in the surround view without an obstructing lens that is coupled to the apparatus.

14. The apparatus of claim 12, wherein the means for providing a surround view comprises means for avoiding reverse stereoscopic parallax based on an interchange of images corresponding to different lens pairs between the first ellipsoid view and the second ellipsoid view.

15. A method, comprising:
obtaining a plurality of images from a respective plurality of lenses; and
avoiding an obstructing lens based on rendering a stereoscopic surround view comprising a first rendering ellipsoid and a second rendering ellipsoid, wherein rendering the stereoscopic surround view comprises natively mapping a first image of the plurality of images to a first range of the first rendering ellipsoid and natively mapping the first image to a second range of the second rendering ellipsoid.

16. The method of claim 15, wherein rendering the stereoscopic surround view comprises avoiding reverse stereoscopic parallax, comprising natively mapping the plurality of images to the first rendering ellipsoid and natively mapping the plurality of images to the second rendering ellipsoid, wherein the plurality of images are natively mapped to different ranges of the first rendering ellipsoid and the second rendering ellipsoid.

17. The method of claim 15, wherein the plurality of lenses are mounted on a vehicle, and wherein the stereoscopic surround view is utilized in an Advanced Driver Assistance System (ADAS).

18. The method of claim 15, wherein the plurality of lenses are mounted on one or more drones.

19. The method of claim 15, wherein at least one of the plurality of lenses has a field of view greater than 180 degrees.

20. The method of claim 15, wherein the plurality of images comprises a first hemiellipsoid, a second hemiellipsoid, a third hemiellipsoid, and a fourth hemiellipsoid, wherein the first rendering ellipsoid is a left rendering ellipsoid and the second rendering ellipsoid is a right rendering ellipsoid, and wherein the left rendering ellipsoid comprises at least a portion of the first hemiellipsoid in the first range, at least a portion of the second hemiellipsoid in the second range, at least a portion of the fourth hemiellipsoid in a third range, and at least a portion of the third hemiellipsoid in a fourth range, and wherein the right rendering ellipsoid comprises at least a portion of the third hemiellipsoid in the first range, at least a portion of the first hemiellipsoid in the second range, at least a portion of the second hemiellipsoid in the third range, and at least a portion of the fourth hemiellipsoid in the fourth range.

21. The method of claim 15, further comprising performing at least one of blending and fading between at least two of the plurality of images.

22. The method of claim 15, further comprising projecting the plurality of images directly to the first rendering ellipsoid and the second rendering ellipsoid to avoid performing realignment.

23. A computer-program product, comprising a non-transitory tangible computer-readable medium having instructions thereon, the instructions comprising:
code for causing an electronic device to obtain a plurality of images from a respective plurality of lenses; and
code for causing the electronic device to avoid an obstructing lens based on code for causing the electronic device to render a stereoscopic surround view comprising a first rendering ellipsoid and a second rendering ellipsoid, wherein the code for causing the electronic device to render the stereoscopic surround view comprises code for causing the electronic device to natively map a first image of the plurality of images to a first range of the first rendering ellipsoid and to natively map the first image to a second range of the second rendering ellipsoid.

24. The computer-program product of claim 23, wherein the code for causing the electronic device to render the stereoscopic surround view comprises code for causing the electronic device to avoid reverse stereoscopic parallax, comprising code for causing the electronic device to natively map the plurality of images to the first rendering ellipsoid and to natively map the plurality of images to the second rendering ellipsoid, wherein the plurality of images are natively mapped to different ranges of the first rendering ellipsoid and the second rendering ellipsoid.

25. The computer-program product of claim 23, wherein the plurality of lenses are mounted on a vehicle, and wherein the stereoscopic surround view is utilized in an Advanced Driver Assistance System (ADAS).

26. The computer-program product of claim 23, wherein the plurality of lenses are mounted on one or more drones.

27. The computer-program product of claim 23, wherein at least one of the plurality of lenses has a field of view greater than 180 degrees.

28. The computer-program product of claim 23, wherein the plurality of images comprises a first hemiellipsoid, a second hemiellipsoid, a third hemiellipsoid, and a fourth hemiellipsoid, wherein the first rendering ellipsoid is a left rendering ellipsoid and the second rendering ellipsoid is a right rendering ellipsoid, and wherein the left rendering ellipsoid comprises at least a portion of the first hemiellipsoid in the first range, at least a portion of the second hemiellipsoid in the second range, at least a portion of the fourth hemiellipsoid in a third range, and at least a portion of the third hemiellipsoid in a fourth range, and wherein the right rendering ellipsoid comprises at least a portion of the third hemiellipsoid in the first range, at least a portion of the first hemiellipsoid in the second range, at least a portion of the second hemiellipsoid in the third range, and at least a portion of the fourth hemiellipsoid in the fourth range.

29. The computer-program product of claim 23, further comprising code for causing the electronic device to perform at least one of blending and fading between at least two of the plurality of images.

30. The computer-program product of claim 23, further comprising code for causing the electronic device to project the plurality of images directly to the first rendering ellipsoid and the second rendering ellipsoid to avoid performing realignment.
